(19) United States
(12) Patent Application Publication
(10) Pub. No.: US 2003/0074448 A1
(43) Pub. Date: Apr. 17, 2003

(54) Multimedia information system and computer program

(76) Inventors: Tadashi Kinebuchi, Okaya-shi (JP); Takao Ozawa, Shiojiri-shi (JP); Yu Gu, Tokyo (JP); Tsunemori Asahi, Nagano-ken (JP); Hiroaki Kanisawa, Tokyo-to (JP); Hiroyasu Fukazawa, Suwa-shi (JP)

Correspondence Address: HOGAN & HARTSON L.L.P., 500 S. GRAND AVENUE, SUITE 1900, LOS ANGELES, CA, 90071-2611, US

(21) Appl. No.: 10/215,253

(22) Filed: Aug. 7, 2002

(30) Foreign Application Priority Data
Aug. 10, 2001 (JP) 2001-244898
Aug. 10, 2001 (JP) 2001-244899
Aug. 10, 2001 (JP) 2001-244900

(51) Int. Cl. G06F 15/16; G06F 15/173

(52) U.S. Cl. 709/225; 709/218; 709/203

(57) ABSTRACT

A request for transition from a process controlled by HTTP protocol to a special process controlled by a protocol different from the HTTP protocol is made by a URL as command transfer means. When the URL is input via an information terminal to a server, a client agent is started on the information terminal side, and an agent service section is started on the sever side. The client agent and the agent service section carry out the special process, such as an authentication process, while bi-directionally transmitting and receiving data to and from each other. A service manager controls the special process such that transition to another process, such as a channel-switching process, is inhibited during execution of the authentication process by the client agent and the agent service section.

### BACKGROUND OF THE INVENTION

1. Field of the Invention

This invention relates to a multimedia information system that is capable of providing various kinds of services and information made available by the use of simple and easy information terminals to operate, and a computer program therefor.

2. Prior Art

Terminals for allowing users to access various kinds of information by simple operations thereof are widely installed in stores, financial institutions, libraries, and other public institutions. These terminals each display desired information on its display e.g. when the user touches the screen with a finger, and print the displayed information as required. For example, at information bureaus in railway stations or the like, terminal systems are also available which have the functions of displaying train services or bus services on displays thereof, and printing time tables. Further, in musical instrument shops, there are installed terminals which have the function of downloading desired performance data to MP3 players or the like. In department stores and the like, there are installed terminals for displaying various kinds of business information, such as information of articles dealt on respective floors. In libraries, terminals are employed for displaying lists of books housed therein and searching for a desired book.

Now, the above conventional technology suffers from the following problems to be solved. If each information terminal is controlled by a browser and various contents are produced in the form of Web pages, it is possible to improve and change contents relatively easily. However, the browser for displaying the Web pages does not basically perform session control. Therefore, it is difficult for the browser to control a process which inhibits transition from a process of authenticating an user to another process, or from a display screen to another having no relation to the display screen. In short, it is impossible to reliably inhibit incorrect control from being executed. As a result, to control a terminal which necessitates the authentication process or the like, it is required to employ another programming technique of providing a program difficult to maintain or rewrite.

Further, the above conventional technology suffers from the following problems to be solved. For example, with a view to attracting customers in a department store, it is contemplated that to provide the information terminals installed therein not only with the function of guiding customers to selling floors but also with many other functions. That is, it is advisable to make information terminals capable of issuing coupon tickets for purchasing articles, and providing information of neighboring shops, or information of games and the like necessitated for other purposes than the purpose of shopping in the department store.

However, conventional systems employed in various fields use so-called customized software and hardware products which are designed in advance to have configurations suitable for the respective systems and exclusively provided therefor. This makes it difficult to expand or change the contents provided by each system. Further, in the case of a retailer having a large number of stores, if the contents provided by the whole system of the retailer are to be sequentially expanded or changed according to users' needs, it takes much time and labor to design the system and rewrite details of programs therefor, which results in an increase in maintenance and management costs.

Furthermore, the above conventional technology suffers from the following problems to be solved. The terminals used in the various fields described above can be relatively improved in expandability and made easier to maintain e.g. providing them with the function of displaying a browser, and providing contents of information in the form of Web pages. Further, it is also possible to construct a system which enables various contents to be accessed by one terminal. If such terminals are arranged in supermarkets or like stores, it can be expected that the degree of utilization of contents is increased and an increased number of customers come to the stores. In the system constructed as above, however, to enhance the degree of utilization of contents, it is required to accurately grasp needs of users of the terminals and their use of the terminals and optimize the kinds or details of contents according to the needs of the users and their use. To meet the requirement, a system is necessitated for collecting data indicating use of contents more accurately and more easily.

### SUMMARY OF THE INVENTION

It is a first object of the invention to provide a multimedia information system in which session control can be performed reliably even under a control environment in which the control is performed by controlling a browser.

It is a second object of the invention to provide a multimedia information system that maximizes the commonality of system components, and at the same time allows services to be customized individually, freely, and easily, e.g. on a store-by-store basis.

It is a third object of the invention to provide a multimedia information system which is capable of collecting data indicative of the use of contents more accurately and more easily.

To attain the above first object, according to a first aspect of the invention, there is provided a multimedia information system comprising:

an information terminal;

a Web server section responsive to a request made by a browser on the information terminal, for selecting a Web page contained in contents to allow the Web page to be read; and

a proxy server section between the information terminal and the Web server section, for controlling the information terminal,

wherein when a URL including a command requesting transition to a special process is input from the browser on the information terminal to the proxy server section, the proxy server section interprets the command by using command-interpreting means to carry out the special process.

According to this multimedia information system, during execution of control of a browser by the HTTP protocol, the proxy server section passes a URL (Uniform Resource Locator) received from the information terminal, to the Web server section to request a corresponding Web page to be read out from a storage device. If a URL including a command is used for control of transition to a special process, the proxy server section is capable of recognizing the URL as the command for control of transition to the special process and processing the same. Any suitable method of incorporating the command in the URL can be employed as desired.

Preferably, the special process is carried out according to a protocol different from an HTTP protocol.

According to this preferred embodiment, control is carried out for transition from a process controlled by the HTTP protocol to the special process, and transition from the special process again to the process controlled by HTTP protocol, whereby control which cannot be effected by the HTTP protocol can be realized. Any suitable kind of a protocol different from the HTTP protocol can be employed for the special process.

Preferably, in the special process, control is carried out for inhibiting transition to another process until acquisition of required information has been completed.

According to this preferred embodiment, session control for inhibiting transition of the special process to another until acquisition of required information has been completed, which cannot be effected by the HTTP protocol, can be carried out. The term “required information” is intended to mean arbitrary information input via the information terminal. The another process may be carried out by the HTTP protocol or another protocol.

Preferably, the URL including the command requesting transition to the special process comprises a URL portion indicative of a site storing a command-interpreting program, and a command portion indicating a command corresponding to the requested special process as a parameter.

According to this preferred embodiment, since the command-interpreting program is started by using the URL including the command requesting transition to the special process, the place storing the command-interpreting program and the command indicative of the requested special process are used as parameters. This makes it possible to start a desired program by using the HTTP protocol.

Preferably, when the proxy server section receives the URL including the command requesting transition to the special process, the proxy server section executes a redirect processing for returning a response having a partially dynamic parameter embedded in an entity portion thereof and containing files of a client agent to the information terminal, as a response to a URL request having been automatically generated and prepared in advance.

According to this preferred embodiment, when the proxy server section receives the URL including the command requesting transition to the special process, the special process is started. At this time, a client agent is started on the information terminal side. Therefore, the response to a URL request is returned as if it is transmitted from the Web server. This process is called “the redirect processing”. The files of the client agent constitute a program for starting the client agent on the information terminal side.

Preferably, the proxy server section establishes a socket in response to a communication request made by the client agent on the information terminal, starts part of a program provided in advance for independent operation, and executes a process for a particular service while bi-directionally transmitting and receiving data to and from the client agent.

According to this preferred embodiment, the proxy server section establishes a bi-directional communication line between the same and the client agent to execute the special process. This makes it possible to carry out the special process which is different from that by the HTTP protocol and inhibits transition to another process.

Preferably, the proxy server section carries out exclusive control for inhibiting a plurality of special processes from being started simultaneously, and at the same time inhibits interruption of the special process once started.

According to this preferred embodiment, the exclusive control and the interruption-inhibiting control enables reliable session control to be executed by the special process.

Preferably, the proxy server section customizes the part of the program provided in advance for independent operation as the particular service on a channel-by-channel basis.

According to this preferred embodiment, an authentication process can be set channel by channel by designing the part of the program freely provided in advance for independent operation.

Preferably, commands peculiar to respective channels are set on a channel-by-channel basis.

According to this preferred embodiment, by setting commands freely, it becomes possible to perform control peculiar to each channel.

To attain the above first object, according to a second aspect of the invention, there is provided a computer program for a network including a Web server section responsive to a request made by a browser on an information terminal, for selecting a Web page contained in contents to allow the Web page to be read, and a proxy server section between the information terminal and the Web server section, for controlling the information terminal,

the computer program causing, when a URL including a command requesting transition to a special process is input from the browser on the information terminal to the proxy server section, a computer of a server to carry out the special process by interpreting the command by using command-interpreting means.

Preferably, the special process is carried out according to a protocol different from an HTTP protocol.

Preferably, the computer program causes the computer of the server to carry out control for inhibiting transition to another process until acquisition of required information has been completed, in the special process.

Preferably, the URL including the command requesting transition to the special process comprises a URL portion indicative of a site storing a command-interpreting program, and a command portion indicating a command corresponding to the requested special process as a parameter.

Preferably, the computer program causes, when the URL including the command requesting transition to the special process is received from a network side, the computer of the server to carry out processing for executing a redirect processing for returning a response having a partially dynamic parameter embedded in an entity portion thereof and containing files of a client agent to the network side, as a response to the URL request having been automatically generated and prepared in advance.

Preferably, the computer program causes the computer of the server to carry out processing for establishing a socket in response to a communication request made by the client agent on the network side, starting part of a program provided in advance for independent operation, and executing a process for a particular service including an authentication process while bi-directionally transmitting and receiving data to and from the client agent.

Preferably, the computer program causes the computer of the server to carry out exclusive control for inhibiting a plurality of special processes from being started simultaneously, and at the same time to perform processing for inhibiting interruption of the special process once started.

Preferably, the computer program causes the computer of the server to carry out processing for customizing the part of the program provided in advance for independent operation as the particular service on a channel-by-channel basis.

Preferably, the computer program causes the computer of the server to carry out processing for setting an original command for each channel.

To attain the above first object, according to a third aspect of the invention, there is provided a computer program for causing a computer of a server to carry out:

processing for causing a Web server section to select a Web page contained in contents to allow the Web page to be read in response to a request input via a network,

processing for causing a proxy server section to respond to a predetermined URL-based request entered via the network, and

processing for causing the proxy server section to interpret a command by using command-interpreting means to execute a special process, when a URL including the command requesting transition to the special process is input to the proxy server section via the network.

To attain the above first object, according to a fourth aspect of the invention, there is provided a computer program for causing a computer of a server to carry out processing for selecting a Web page contained in contents to allow the Web page to be read in response to a request input via a network, and

processing for responding to a predetermined URL-based request entered via the network, and

wherein the computer program causes, when a URL including a command requesting transition to a special process is input to a proxy server section via the network, the computer of the server to execute a special process for causing the proxy server section to interpret the command by using command-interpreting means.

To attain the above first object, according to a fifth aspect of the invention, there is provided a multimedia information system including a Web server section for selecting a Web page contained in contents to allow the Web page to be read via a network, and a proxy server section directly connected to the network,

wherein when a URL including a command requesting transition to a special process is input to the proxy server section via the network, the proxy server section interprets the command by using command-interpreting means, and executes the special process.

Preferably, the special process is carried out according to a protocol different from an HTTP protocol.

Preferably, in the special process, control is carried out for inhibiting transition to another process until acquisition of required information has been completed.

Preferably, the URL including the command requesting transition to the special process comprises a URL portion indicative of a site storing a command-interpreting program, and a command portion indicating a command corresponding to the requested special process as a parameter.

Preferably, when the proxy server section receives the URL including the command requesting transition to the special process from a network side, the proxy server section executes a redirect processing for returning a response having a partially dynamic parameter embedded in an entity portion thereof and containing files of a client agent to the network side, as a response to the URL request having been automatically generated and prepared in advance.

Preferably, the proxy server section establishes a socket in response to a communication request made by the client agent on the network side, starts part of a program provided in advance for independent operation, and executes a process for a particular service while bi-directionally transmitting and receiving data to and from the client agent on the network side.

Preferably, the proxy server section carries out exclusive control for inhibiting a plurality of special process from being started simultaneously, and at the same time inhibits interruption of the special process once started.

Preferably, the proxy server section customizes the part of the program provided in advance for independent operation as the particular service on a channel-by-channel basis.

Preferably, commands peculiar to respective channels are set on a channel-by-channel basis.

To attain the above second object, according to a sixth aspect of the invention, there is provided a multimedia information system comprising:

content distribution means; and

a server connected to the content distribution means via a network,

wherein contents stored in the server are formed by groups of Web pages such that the groups are independent of each other and provided on a channel-by-channel basis, and

wherein the server designates contents by channel and receives contents of a designated channel distributed by the content distribution means in a predetermined timing.

This multimedia information system includes content distribution means and a server. The content distribution means distributed contents designated by channel to the server via the network. The content distribution means can be any suitable means so long as it has computer capable of collecting contents by an arbitrary method, and distributing them via a network. The contents are formed by groups of Web pages such that the groups are independent of each other and provided on a channel-by-channel basis. Since the contents are independent of each other, when a group of Web pages of one channel is produced, there is no need to be conscious of linkage with groups of Web pages of other channels, thereby making it possible to produce groups of Web pages independent of each other freely at a desired time. The types and formats of contents can be selected as desired. The contents may be advertisement Web pages, or they may be moving pictures, music, video games, and the like. The server freely designates contents by channel to download the same from the content distribution means. The timing of downloading the contents can be set freely. Since the contents can be designated by channel, each server can provide a desired number of groups of Web pages.

To attain the above second object, according to a seventh aspect of the invention, there is provided a multimedia information system comprising:

content distribution means;

a server connected to the content distribution means via a network; and

information terminals for utilizing contents stored in the server,

wherein the contents are formed by groups of Web pages such that the groups are independent of each other and provided on a channel-by-channel basis, and

wherein the server designates contents by channel and receives contents of a designated channel distributed by the content distribution means in a predetermined timing.

According to this multimedia information system, the server has a desired number of information terminals connected thereto to allow utilization of the contents. Each information terminal is capable of selecting a desired one of the contents distributed to the server to which it is connected and displaying Web pages for utilization. The information terminals can be connected to the server by any suitable method. Further, they can have any suitable construction. The server and the information terminals may be connected to each other via a wide area network, such as a phone communication network.

Preferably, when the server receives data of the contents of the designated channel distributed from the content distribution means, the server produces a channel selection screen based on information contained in the distributed data.

According to this preferred embodiment, it is possible to designate and use groups of Web pages as required on a channel-by-channel basis in each server, and hence whenever contents of a designated channel are distributed, the server can produce a channel selection screen based on information contained in the distributed data.

Preferably, each of the information terminals displays the channel selection screen after a start thereof, and

wherein when any channel is selected by operation on the channel selection screen, the information terminal displays a start screen or login screen for the selected channel.

According to this preferred embodiment, each information terminal automatically starts a browser when it is started, and displays the channel selection screen. When any of the channels is selected by operating on the channel selection screen, a start screen or login screen for login to the selected channel is displayed. On the login screen, a user authentication process is executed, and after completion of the process, a Web page of a desired contents of the selected channel can be read.

Preferably, the content distribution means automatically distributes contents designated by channel to a large number of servers via the network in the predetermined timing.

According to this preferred embodiment, for example, the content distribution means automatically distributes contents designated by channel to a large number of servers via the network. This automatic distribution makes it possible to quickly distribute to each server installed in a lot of stores contents designated by the server without fail. It should be noted that the system may be configured such that the content distribution means polls the servers to periodically transmit contents, or that the servers are connected to the content distribution means according to a predetermined schedule to receive contents. In short, the form of distribution can be configured freely.

Preferably, the content distribution means automatically distributes contents via the network based on content distribution-designating data stored in a predetermined storage area of the server.

According to this preferred embodiment, each of the servers stores the content distribution-designating data in the storage area thereof in advance. The content distribution means distributes contents to each server before the start of business operations every day. Contents of designated channels are automatically stored in the storage device of the server according to the content distribution-designating data.

Preferably, the server selects contents designated by the content distribution-designating data from the contents distributed via the network, and stores the selected contents in dedicated folders therefor on a channel-by-channel basis.

According to this preferred embodiment, the server selects contents designated by the content distribution-designating data from the contents distributed via the network, and stores the contents in respective dedicated folders therefor. Contents of all the channels are distributed to the server. The server selects a required one from the contents to use the same for services. This makes it possible to reduce processing load due to distribution of contents on the side of the content distribution means.

Preferably, contents of each channel distributed by the content distribution means are stored separately in a dedicated folder therefor in the server.

According to this preferred embodiment, the contents of each channel are downloaded into a corresponding dedicated folder in the each server. The contents of the channel are stored separately in the dedicated folders. The dedicated folders for the contents of the respective channels make it possible to allow the contents to be read while physically distinguishing channels of the contents from each other.

Preferably, attribute data for use in displaying the channel selection screen is distributed from the content distribution means to the dedicated folder.

Preferably, the attribute data distributed to the dedicated folder for use in displaying the channel selection screen includes information containing description of contents peculiar to each channel.

According to these preferred embodiments, attribute data and modules for use in displaying the channel selection screen are distributed from the content distribution means to the dedicated folders. The attribute data and the module for use in displaying the channel selection screen include information e.g. of icons and titles peculiar to the respective channels, descriptions of contents peculiar to the respective channels, and an operating method of operating the contents. If the attribute data for use in displaying the channel selection screen is distributed from the content distribution means, it is possible to use original channel selection screens according to the configuration of each channel. In this case, it is preferable that information containing descriptions of the contents peculiar to the respective channels is displayed on the channel selection screen.

Preferably, whenever contents of each channel are distributed, the server produces a channel selection screen for selection of any of all usable channels, based on the information added to the contents distributed.

Preferably, the server includes a storage device, and selects contents designated by content distribution-designating data from the contents distributed via the network and stores the selected contents in dedicated folders therefor on a channel-by-channel basis, attribute data for use in displaying the selection screen being distributed from the content distribution means to each of the folders, the server producing the channel selection screen and storing the produced data in the storage device, each information terminal, after a start thereof, reading out the channel selection screen from the storage device of the server for display.

According to these preferred embodiments, whenever contents of the respective channels are distributed, the server automatically produces a channel selection screen for selecting any of all the usable channels, and stores the channel selection screen in the storage device. If information of the channel selection screen has been added to contents distributed, the channel selection screen can be updated whenever the distributed contents are received. Each information terminal, after the start thereof, reads out the channel selection screen from the storage device of the server for display. As a result, each server can freely designate channels to have corresponding contents distributed, and change designation of channels at any time.

Preferably, the contents are distributed as units independent of each other, for respective channels, and the respective channels serve as imaginary Web sites independent of each other on the server.

According to this preferred embodiment, the contents are distributed in units independent of each other on a channel-by-channel basis. The respective channels serve as imaginary Web sites independent of each other on the server. This enables each Web site to permit login of a user by performing an authentication process, carry out a charging process, and provide services.

Preferably, each information terminals, after being switched on, automatically starts a browser to display the channel selection screen.

According to this preferred embodiment, each information terminal has a non-volatile storage device, such as a flash memory or the like, in which an operating system is installed, and after being switched on, automatically starts the browser to display the channel selection screen. Then, the information terminal starts a program, such as Web server software, or additional software. Therefore, it is possible to shorten a start wait time period as well as facilitate operation of the information terminal. In the information terminal, if a Java or the Java applet developed by Sun Microsystems, Inc., or like programs are used, it is possible to cause the information terminal to operate a printer, work with a POS system and read magnetic cards. For example, if a content containing the guide and advertisement of an article is designated, a coupon ticket or the like for purchasing the article can be printed by a printer connected to the information terminal. Further, if a content which can be used only by registered users is designated, an authentication card-reading device can also be connected to the information terminal.

To attain the above second object, according to an eighth aspect of the invention, there is provided a computer program for causing a computer controlling content distribution means to carry out processing for automatically distributing, via a network, contents formed by groups of Web pages such that the groups are independent of each other and provided on a channel-by-channel basis, for storage in a server connected to the content distribution means via the network, based on content distribution-designating data stored in a predetermined storage area of the server.

The above computer program is used on the side of the operation center.

To attain the above second object, according to a ninth aspect of the invention, there is provided a computer program for causing a computer controlling a server to carry out processing for designating contents formed by groups of Web pages such that the groups are independent of each other and provided on a channel-by-channel basis, by channel, to receive contents of a designated channel distributed from a content-distributing side in a predetermined timing, for storage in the server.

The above computer program is used on the side of the server.

Preferably, when the server receives data of the contents of the designated channel distributed from a content-distributing side, the computer program causes the computer controlling the server to carry out processing for producing a channel selection screen based on information contained in the distributed data.

Preferably, the computer program causes a computer for content distribution means to carry out processing for automatically distributing the contents designated by channel to a large number of servers via a network in a predetermined timing.

Preferably, the computer program causes the computer controlling the server to carry out processing for selecting contents designated by content distribution-designating data from the contents distributed via the network, and storing the selected contents in respective dedicated folders therefor on a channel-by-channel basis.

Preferably, the computer program causes the computer controlling the server to carry out processing for storing the contents of each channel distributed by the content distribution means separately in a dedicated folder therefor in the server.

Preferably, the computer program causes the computer controlling the server to carry out processing for having attribute data distributed from the content distribution means to each folder, for use in displaying the selection screen.

Preferably, the computer program causes the computer controlling the server to carry out processing for causing information including description of contents peculiar to each channel to be included in the attribute data distributed to the dedicated folder for being displayed on the channel selection screen.

Preferably, the computer program causes the computer controlling the server to carry out processing for producing a channel selection screen for selection of any of all usable channels, based on the information added to the contents of the each channel whenever the contents are distributed.

To attain the above second object, according to a tenth aspect of the invention, there is provided a multimedia information system comprising a server connected to a content-distributing side via a network,

wherein contents stored in the server are formed by groups of Web pages such that the groups are independent of each other and provided on a channel-by-channel basis, and

wherein the server designates contents by channel to receive contents of a designated channel distributed from the content-distributing side in a predetermined timing.

In this case, the content-distributing side is constructed as desired.

To attain the above second object, according to an eleventh aspect of the invention, there is provided a multimedia information system comprising:

a server connected to a content-distributing side via a network; and

information terminals for utilizing contents stored in the server,

wherein the contents are formed by groups of Web pages such that the groups are independent of each other and provided on a channel-by-channel basis, and

wherein the server designates contents by channel and receives contents of a designated channel distributed from the content-distributing side in a predetermined timing.

In this case as well, the content-distributing side is constructed as desired.

Preferably, when the server receives data of the contents of the designated channel are distributed from the content-distributing side, the server produces a channel selection screen based on information contained in the distributed data.

Preferably, each information terminal displays the channel selection screen after a start thereof, and when any channel is selected by operation on the channel selection screen, a start screen or login screen for the selected channel is displayed.

Preferably, the server receives the contents of the designated channel automatically distributed in a predetermined timing from the content-distributing side via the network.

Preferably, the content-distributing side includes content distribution means for automatically distributing contents via the network based on content distribution-designating data stored in a predetermined storage area of the server.

Preferably, the server selects contents designated by the content distribution-designating data from the contents distributed via the network, and stores the selected contents in respective dedicated folders therefor on a channel-by-channel basis.

Preferably, contents of each channel distributed by the content distribution means are stored separately in a dedicated folder therefor in the server.

Preferably, attribute data for use in displaying the selection screen is distributed from the content distribution means to the dedicated folder.

Preferably, the attribute data distributed to the dedicated folder, for use in displaying the selection screen, includes information containing description of contents peculiar to each channel.

Preferably, whenever the contents of each channel are distributed, the server produces a channel selection screen for selection of any of all usable channels, based on the information added to the contents distributed.

Preferably, the server includes a storage device, and selects contents designated by content distribution-designating data from the contents distributed via the network and stores the selected contents in dedicated folders therefor on a channel-by-channel basis, attribute data being distributed from the content distribution means to each of the folders, for use in displaying the selection screen, the server producing data of the channel selection screen and storing the produced data in the storage device, each information terminal, after a start thereof, reading out the channel selection screen from the storage device of the server for display.

Preferably, the contents are distributed as units independent of each other, for respective channels, and the respective channels serve as imaginary Web sites independent of each other on the server.

Preferably, each information terminal, after being switched on, automatically starts a browser to display the channel selection screen.

To attain the above third object, according to a twelfth aspect of the invention, there is provided a multimedia information system including a server for allowing contents to be read via a network for utilization thereof, wherein the server comprises means for generating and storing log data which contains user identification data for identifying users utilizing the contents and URLs of read Web pages.

According to this multimedia information system, the server has a Web server function of allowing the information terminal to read and utilize desired contents formed by Web pages via the network. The user identification data is obtained e.g. when it is input for authentication of a user at a time of login of the user of the information terminal. By producing log data containing user identification data and URLs (Uniform Resource Locators) of Web pages requested for reading, it is possible to record what Web pages the user read. This record serves as information for grasping the needs of users.

To attain the above third object, according to a thirteenth aspect of the invention, there is provided a multimedia information system including a server, and an information terminal for making use of contents stored in the server, and wherein the server comprises means for generating and storing log data which contains user identification data input by operating the information terminal and URLs of Web pages reading of which was requested by the information terminal.

According to this multimedia information system, the information terminal may be a dedicated terminal provided with contents only by the server, or an arbitrary terminal connected to the server via the Internet or the like.

Preferably, the server acquires the user identification data during execution of a login process when a group of contents starts to be read.

According to this preferred embodiment, the user identification data, which is input during login of the user of the information terminal, is used not only for authentication of the user but also for production of log data. The term “a group of contents” is intended to mean contents demanding an authentication process before being allowed read them.

Preferably, the server acquires the user identification data when the information terminal logs in.

According to this preferred embodiment, if user identification data for identifying a user is obtained whenever the dedicated information terminal for the server logs in, the server can obtain information of Web pages read by the user until the information terminal logs off.

Preferably, the server includes a storage device, and produces and holds a category list in which a URL of each Web page stored in the storage device of the server for being read and a keyword contained in the each Web page are associated with each other.

It is impossible to know the contents of Web pages the user directly read only from the log data in which user identification information and URLs are associated with each other. There is no problem so long as the correspondence between the URLs and the Web pages are fixed. However, it is impossible to effectively make use of the log data without further processing, when the content of each Web page in the storage device of the server can be rewritten as desired. To cope with the above problem, according to this preferred embodiment, a category list is produced in advance in which a URL of each Web page and a keyword contained in the each Web page are associated with each other, thereby making it possible to know what contents of Web pages the user has read, from a combination of the category list and the log data.

Preferably, the server includes a storage device, and a content manager that extracts a keyword from each Web page newly stored in the storage device for being read, and produces a category list in which a URL of the each Web page and the keyword contained in the each Web page are associated with each other.

According to this preferred embodiment, whenever a new Web page is stored in the storage device of the server, if the content manager extracts a keyword from the Web page to produce a category list in which a URL of the Web page and the keyword contained in the Web page are associated with each other, the URL of the Web page and the content thereof can be always shown explicitly. The term “keyword” is intended to mean arbitrary information contained in a Web page and indicating the content of the Web page. Keywords are only required to be contained in HTML data forming Web pages, and, for example, one which is included in part of a title-tag, and not displayed on the screen of the browser may be employed.

Preferably, the server includes a storage device, and a content manager that extracts an abstract from a predesignated portion of each Web page newly stored in the storage device for being read, and produces a category list in which a URL of the each Web page and the abstract in the each Web page are associated with each other.

According to this preferred embodiment, the category list may be one in which a URL of Web each page and the abstract contained therein area associated with each other.

Preferably, the server includes a storage device, and stores contents formed by groups of Web pages such that the groups are independent of each other and provided on a channel-by-channel basis, in dedicated folders of the storage device, respectively, and the server includes a proxy server section for executing a login process for each channel, and holding user identification data input during execution of the login process until logoff from the channel.

According to this preferred embodiment, the contents are formed by groups of Web pages such that the groups are independent of each other and provided on a channel-by-channel basis. Since the contents are independent of each other, when a group of Web pages of one channel is produced, there is no need to be conscious of linkage with groups of Web pages of other channels. This makes it possible to produce respective groups of Web pages independent of each other freely in a desired timing. The types and constructions of contents can be selected as desired. The contents may be advertisement Web pages, or they may be moving pictures, music, video games, and the like. The proxy server section of the server executes a login process channel by channel to hold user identification information from a time point of the start of the login process to a time point of termination of a logoff process. When the channel is switched, a new login process is executed to obtain user identification information. Thus, the server can freely change details of contents channel by channel, thereby utilizing groups of Web pages as it requires. The server has a desired number of information terminals connected thereto to allow the contents to be utilized. Each information terminal is capable of selecting a desired one of the contents distributed to the server to which it is connected and displaying Web pages for utilization. The information terminal can be connected to the server by a desired method, and constructed as desired. The server and the information terminals may be connected to each other via a wide area network, such as a phone communication network.

Preferably, the information terminal displays a channel selection screen after a start thereof, and when any channel is selected by operation on the channel selection screen, the information terminal displays a login screen for login to the any channel.

According to this preferred embodiment, each information terminal automatically starts a browser when it is started, and displays the channel selection screen. When any of the channels is selected by operating on the channel selection screen, a login screen for login to the selected channel is displayed. On the login screen, a user authentication process is executed, and after completion of the process, a Web page of a desired content of the selected channel can be read.

Preferably, the multimedia information system includes content distribution means for automatically distributing contents designated by channel to a large number of servers via a network in a predetermined timing.

According to this preferred embodiment, the content distribution means is connected to a large number of servers via the network. The content distribution means automatically distributes contents designated by channel to the large number of servers. This automatic distribution makes it possible, for example, to quickly distribute to each of servers installed in a lot of stores, contents designated by the server without fail. It should be noted that the system may be configured such that the content distribution means polls the servers to periodically transmit contents, or that the servers are connected to the content distribution means according to a predetermined schedule to receive contents. In short, the form of distribution can be set freely.

Preferably, the server transmits the log data to the content distribution means via the network in a predetermined timing.

According to this preferred embodiment, the log data is transmitted to the content distribution means, and URLs used by users are checked, whereby it is possible to optimize contents distributed from the content distribution means.

Preferably, the server transmits the log data and the category list in which the URL of the each Web page and the keyword contained in the each Web page are associated with each other to the content distribution means via the network in a predetermined timing.

According to this preferred embodiment, the server automatically and periodically transmits the log data to the content distribution means. If the log data and the category data are collated with each other, it is possible to edit information of what contents of Web pages each user has read. This method is effective if the contents of a Web page cannot be specified only by using URLs.

Preferably, the content distribution means includes means for producing accumulated information in which user identification information of all users using the server and keywords of Web pages read by any of the users are associated with each other, based on the user identification information contained in the log data transmitted from the server, the URLs contained in the category list, and the keywords contained in the Web pages.

Preferably, the content distribution means includes means for producing accumulated information in which user identification information of all users using the server and abstracts of Web pages read by any of the users are associated with each other, based on the user identification data contained in the log data transmitted from the server, the URLs contained in the category list, and the abstracts contained in the Web pages.

According to these preferred embodiments, the accumulated information in which user identification information of users and keywords or abstracts of Web page read by users are associated with each other is automatically produced by the content distribution means, whereby it is possible to obtain data for optimizing the contents. The contents and formats of the accumulated information can be selected as desired. The accumulated information may be formed in data format or in print document format output to a department in charge.

Preferably, the content distribution means includes means for analyzing the accumulated information to extract a tendency of use of contents on a server-by-server basis, and producing content selection information for being distributed to each server.

Preferably, the content distribution means includes means for analyzing the accumulated information to extract a tendency of use of contents on a user-by-user basis, and producing content selection information to be distributed to each server.

According to these preferred embodiments, information for selecting the optimum content to be transmitted to the server can be produced by analyzing a tendency of use of contents on a server-by-server basis. The content selection information may be data for automatically selecting a content, or data for displaying candidates of channels including contents to be distributed to the server.

Preferably, when the server acquires the user identification information of a user in the login process, the server produces and displays a dedicated menu screen for the user based on the accumulated information.

According to this preferred embodiment, the accumulated information is produced as above, and hence as the user uses the information terminal more frequently, he can obtain an environment wherein the information terminal can be used more easily.

To attain the above third object, according to a fourteenth aspect of the invention, there is provided a computer program for causing a computer of a server for allowing contents to be read via a network for utilization thereof, to carry out processing for producing and storing log data which contains user identification data of users utilizing the contents and URLs of read Web pages.

To attain the above third object, according to a fifteenth aspect of the invention, there is provided a computer program for causing a computer of a server allowing contents to be read and utilized by an information terminal to carry out processing for producing and storing log data which contains user identification data input by operation on the information terminal and URLs of Web pages reading of which was requested by the information terminal.

Preferably, the computer program causes the computer of the server to carry out processing for acquiring the user identification data during execution of a login process when a group of contents starts to be read.

Preferably, the computer program causes the computer of the server to carry out processing for acquiring the user identification data when the information terminal logs in.

Preferably, the server includes a storage device, and the computer program causes the computer of the server to carry out processing for producing and holding a category list in which a URL of each Web page stored in a storage device of the server for being read, and a keyword contained in the each Web page are associated with each other.

Preferably, the server includes a storage device, and the computer program causes the computer of the server is caused to carry out processing for extracting a keyword from each Web page newly stored in the storage device for being read, and producing a category list in which a URL of the each Web page and the keyword contained in the each Web page are associated with each other.

Preferably, the server includes a storage device, and the computer program causes the computer of the server to carry out processing for extracting an abstract from a predesignated portion of each Web page newly stored in the storage device for being read, and producing a category list in which a URL of the each Web page and the abstract in the each Web page are associated with each other.

Preferably, the server includes a storage device, and the computer program causes the computer of the server to carry out processing for storing contents formed by groups of Web pages such that the groups are independent of each other and provided on a channel-by-channel basis in respective dedicated folders of the storage device, executing a login process for each channel, and holding user identification data input during execution of the login process until logoff from the channel.

To attain the above third object, according to a sixteenth aspect of the invention, there is provided a computer program causing a computer of a server allowing contents to be read and utilized by an information terminal to carry out processing for producing and storing log data which contains user identification data input by operating the information terminal and URLs of Web pages reading of which was requested by the information terminal, and

wherein the computer program causes, when the information terminal displays a channel selection screen containing the contents after a start thereof, and any channel is selected by operation on the channel selection screen, a login screen of a selected channel to be displayed on the information terminal.

Preferably, the computer program causes the computer of the server to carry out processing for automatically receiving contents designated by channel in a predetermined timing via the network.

Preferably, the computer program causes the computer of the server to carry out processing for transmitting the log data to content distribution means in a predetermined timing via the network.

Preferably, the computer program causes the computer of the server to carry out processing for transmitting the log data and the category list in which the URL of each Web page and the keyword contained in the each Web page are associated with each other to content distribution means via the network in a predetermined timing.

To attain the above third object, according to a seventeenth aspect of the invention, there is provided a computer program for causing, after a server allowing contents to be read via a network for utilization thereof carries out processing for producing and storing log data which contains user identification data of users utilizing the contents and URLs of read Web pages, a computer of content distribution means to carry out processing for producing accumulated information in which user identification information of all users using the server and keywords of Web pages read by any of the users are associated with each other, based on the user identification information contained in the log data transmitted from the server, the URLs contained in the category list, and the keywords contained in the Web pages.

To attain the above third object, according to an eighteenth aspect of the invention, there is provided a computer program for causing, after a server allowing contents to be read via a network for utilization thereof carries out processing for producing and storing log data which contains user identification data of users utilizing the contents and URLs of read Web pages, a computer of content distribution means to carry out processing for producing accumulated information in which user identification information of all users using the server and abstracts of Web pages read by any of the users are associated with each other, based on the user identification data contained in the log data transmitted from the server, the URLs contained in the category list, and the abstracts contained in the Web pages.

Preferably, the computer program causes the computer of the content distribution means to carry out processing for analyzing the accumulated information to extract a tendency of use of contents on a server-by-server basis, and producing content selection information to be distributed to each server.

Preferably, the computer program causes the computer of the content distribution means to carry out processing for analyzing the accumulated information to extract a tendency of use of contents on a user-by-user basis, and producing content selection information to be distributed to each server.

To attain the above third object, according to a nineteenth aspect of the invention, there is provided a computer program for causing a computer of a server allowing contents to be read via a network for utilization thereof, to carry out:

processing for producing and storing log data which contains user identification data of users utilizing the contents and URLs of read Web pages, and

processing for producing and displaying a dedicated menu screen for a user, after user identification information of the user has been acquired by carrying out a login process, based on accumulated information produced by a computer of content distribution means such that user identification information of all users using the server and keywords of Web pages read by any of the users are associated with each other, based on the user identification information contained in the log data transmitted from the server, URLs contained in a category list, and information contained in the Web pages.

The above and other objects, features, and advantages of the invention will become more apparent from the following detailed description taken in conjunction with the accompanying drawings.

### BRIEF DESCRIPTION OF THE DRAWINGS

FIG. 1 is a block diagram showing essential blocks of a multimedia information system according to the invention;

FIG. 2 is a block diagram showing an example of the multimedia information system according to the present invention;

FIG. 3A is a diagram useful in explaining the directory structure of a storage area of a storage device in which contents are stored;

FIG. 3B is a flowchart which is useful in explaining operations carried out by a server when the server receives the contents from an operation center;

FIG. 4A is a diagram useful in explaining an example of a selection screen for selecting a channel;

FIG. 4B is a perspective view showing the appearance of an information terminal;

FIG. 5 is a diagram useful in explaining the structure of a content file distributed to each channel;

FIG. 6A shows an example of an operation screen used when the information terminal performs a card authentication process;

FIG. 6B shows an example of an operation screen used when the information terminal performs a process for issuing a coupon ticket;

FIG. 7 is a flowchart showing operations carried out by the server when the information terminal for the system is operated;

FIG. 8 is a flowchart showing main operations carried out by the multimedia information system according to the present invention;

FIGS. 9A to 9C are diagrams which are useful in explaining log data and category lists used in the multimedia information system according to the invention, in which:

FIG. 9A shows an example of the log data;

FIGS. 9B and 9C show examples of the category lists;

FIG. 10 is a flowchart showing an operation for holding user identification data when the information terminal appearing in FIG. 2 has logged in;

FIG. 11 is a flowchart showing a process for updating a category list carried out by operating a content manager section; and

FIG. 12 is a diagram showing an example of a login screen which is formed by making use of accumulated information so as to increase the convenience of each individual user who wishes to use Web pages.

### DETAILED DESCRIPTION OF PREFERRED EMBODIMENTS

The invention will now be described in detail with reference to the drawings showing preferred embodiments thereof.

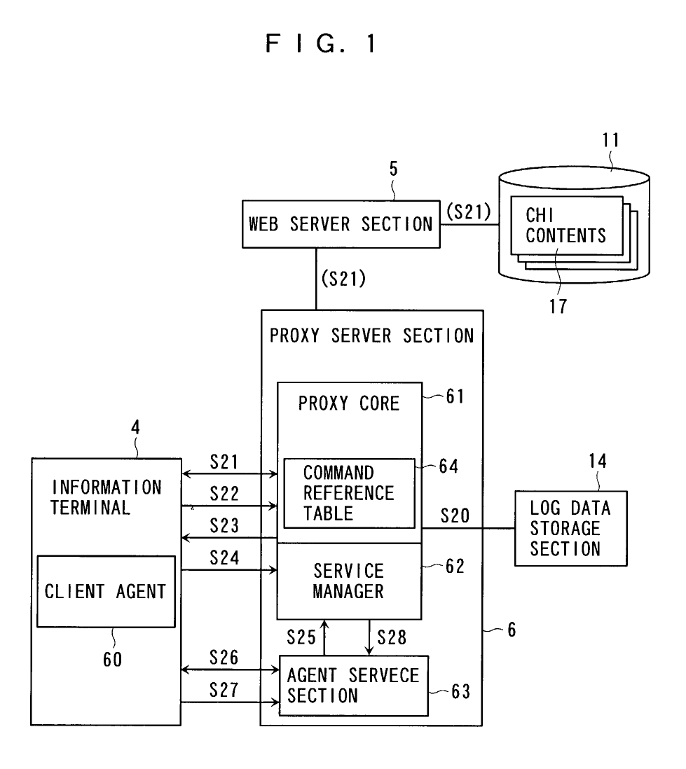

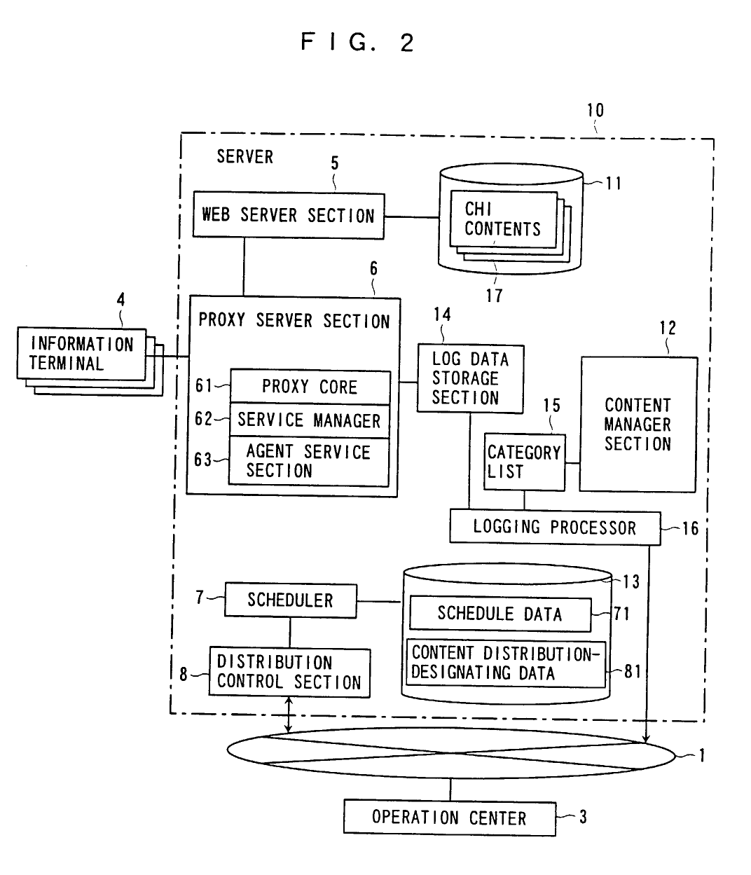

FIG. 1 is a block diagram showing essential sections of a multimedia information system according to the present invention. The figure illustrates only part of a server and an information terminal employed in the system of the present invention. The whole arrangement of the system will be described hereinafter with reference to FIG. 2. Before description thereof, first, only the essential sections of the system are described. A server 10 includes a Web server section 5 and a proxy server section 6. Responsive to a request made by a browser on the information terminal 4, the Web server section 5 has the function of selecting a Web page contained in contents 17 and allowing the Web page to be read. The proxy server section 6 controls the information terminal 4 connected to the server 10. The contents 17 are divided into a plurality of channels independent of each other. When a user desires to use a content 17 of any of the channels, he is requested, e.g. for authentication, to input his member number and password in a logon screen of the information terminal 4.

In a user authentication process, when a user inputs his member number and password via the browser of the information terminal 4, it is determined with reference to a database, not shown, whether or not they are valid, and after authentication of validity of the input, a sequence of processing steps are carried out for displaying screens to allow the user to browse contents. Generally, if an interrupt handling routine is carried out during execution of such processing, data of the member number and password inputted is rewritten or cleared. Therefore, it is necessary to carry out session control for ensuring continuity of the processing. However, since control between the server 10 and the browser of the information terminal 4 is carried out according to the HTTP protocol, it is difficult to reliably carry out the session control. For example, when the user requests reading of contents on a completely different screen during execution of the authentication process on the logon screen, the authentication process is interrupted, and after the interruption, it cannot be necessarily normally resumed. To eliminate this inconvenience, according to the present invention, a specific process, such as an authentication process, a channel shift process (channel-switching process), or the like, is carried out by executing special process different from the process effected according to the HTTP protocol. Before describing details of the above specific process, first, the functions of the whole system of the present invention will be described with reference to FIGS. 2 to 7.

FIG. 2 is a block diagram showing an example of the multimedia information system according to the present invention.

The system shown in the figure is constructed by connecting an operation center 3 and the server 10 via a network 1. The server 10 has a desired number of information terminals 4 connected thereto. The network 1 is formed by a wide area network, such as the Internet, or the like. The server 10 is implemented e.g. by a computer which is provided in each of stores, such as supermarkets, for information service. The information terminals 4 are terminal units arranged at respective locations in the supermarket. The construction of each terminal unit will be described hereinbelow.

The server 10 incorporates the Web server section 5, the proxy server section 6, a scheduler 7, a distribution control section 8, storage devices 11, 13, a content manager section 12, a log data storage section 14, a category list 15, a logging processor 16, and the like. These are functional blocks or sections which are internal or external to the server 10 and operate in an integrated fashion. They are formed by computer programs, data stored in memories, and so forth.

The Web server section 5 carries out control operations for allowing the information terminals 4 to read the contents 17 stored in the storage device 11. The proxy server section 6 carries out main information transmission/reception control including control of man-machine interface provided for users who operate the information terminals 4. The proxy server section 6 includes a proxy core 61, a service manager 62, and an agent service section 63. When one of the information terminals 4 has made a request of access to the Web server section 5 for reading the contents, the proxy core 61 records access log by adding user information thereto for storage in the log data storage section 14. This log information-recording control is carried out so as to obtain data of use of the contents by the user.

The service manager 62 carries out control operations for managing access requests issued from the information terminals 4 to the Web server section 5, for reading the contents, and transferring Web pages received via the Web server section 5 to the information terminals 4. The above management of access requests for accessing Web pages is carried out by the conventional method. The agent service section 63 processes special requests input via the information terminals 4, such as channel-switching requests, and login requests for login to the channels, other than the Web page-reading requests. The proxy server section 6 provided with the above functional blocks or sections is capable of mapping groups of Web pages stored in the storage device 11 on a channel-by-channel basis, in units of management, to present them as contents of imaginary Web sites independent of each other.

The scheduler 7 is used for managing the operations carried out after the server 10 is started until the power of the server 10 is turned off. The scheduler 7 carries out schedule control based on arbitrary schedule data 71 stored in the storage device 13, e.g. to perform control operation for sending log data to the operation center 3 at a fixed time every day. The distribution control section 8 controls a process for receiving contents distributed from the operation center 3, and selecting a required content therefrom for storage in the storage device 11. The distribution control section 8 downloads only the contents of a channel designated by content distribution-designating data 81 stored in the storage device 13, from the operation center 3. If the content distribution-designating data 81 is updated as required in view of use of the contents by the user, it is possible to provide service peculiar to each server.

The content manager section 12 controls a content-updating process, creation of a URL list, and the like. The content manager section 12 subjects data including contents received by the distribution control section 8 to analysis and conversion on a channel-by-channel basis, and manages Web data stored in the storage device 11. The content manager section 12 is configured such that contents to be distributed can be changed on a channel-by-channel basis. Therefore, the contents are replaced with others, the content manager section 12 produces a URL list of all the Web pages, extracts keywords from corresponding Web pages, and generates information of a keyword table in which the extracted keywords are associated with the URLs of the Web pages. The keyword table information can be not only used for searching Web pages but also utilized as data for determining which users used which Web pages at what hours and what information was provided on the Web pages, through collation with the log data. The category list 15 is data including the list of channels which the server has requested to be distributed, and the keyword table information categorized.

The logging processor 16 receives data which is indicative of records of use of each information terminal by each user and stored in the log data storage section 14, and the category list 15 including the list of channels and the keyword table information produced by the content manager section 12, and then automatically transmits the data to the operation center 3 in a predetermined timing. This enables the operation center to grasp details of the data in all the servers 10 and to provide service for providing the information to sectors necessitating the same and service for improving contents to be distributed, as required. The server 10 constructed as above manages contents received from the operation center 3 on a channel-by-channel basis, while the information terminals 4 are configured such that they are capable of selecting and displaying a desired channel to utilize the contents.

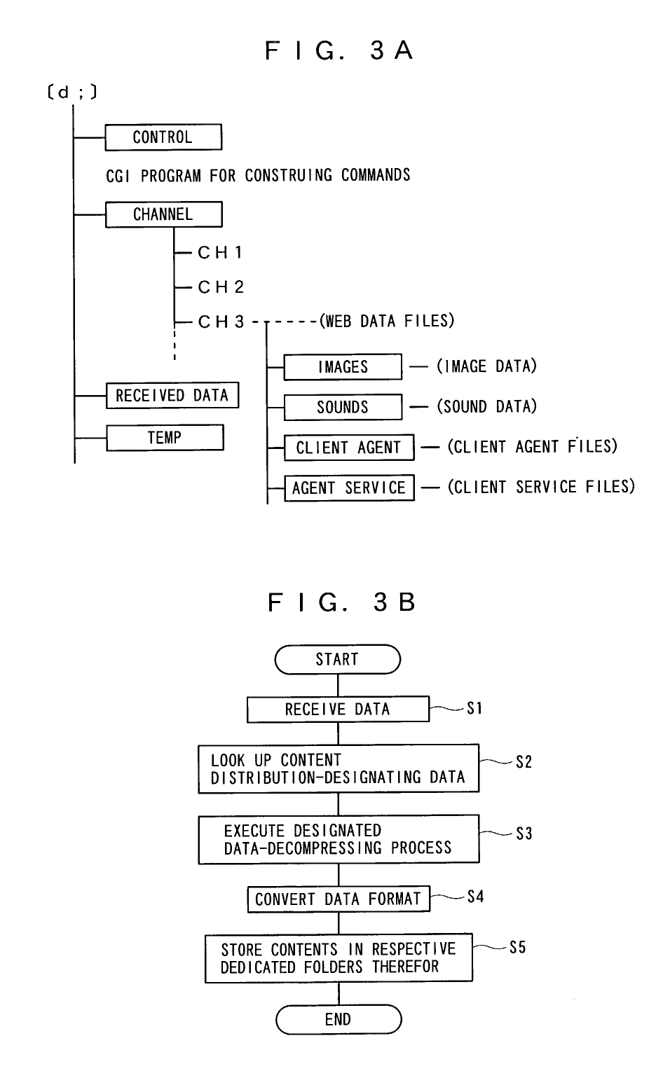

FIG. 3A is a diagram useful in explaining the directory structure of a storage area of the storage device 11, for storing the contents 17. FIG. 3B is a flowchart which is useful in explaining operations carried out by the server 10 when the server 10 receives the contents 17 from the operation center 3.

As shown in FIG. 3A, the directory e.g. of d drive set as a storage area includes a control folder, a channel folder, a received data folder, and a temporary storage folder (TEMP). The control folder contains a CGI program, for example, for interpreting commands for executing control of a special process common to the channels, when the special process is requested via an information terminal 4. The special process includes, for example, a user authentication process, a charging process, a printing process, and so forth. As shown in the figure, the channel folder has subfolders, CH1, CH2, CH3, . . . which are independent of each other and provided on a channel-by-channel basis. In the figure, the subfolder of a channel CH3 is shown in a further unfolded state.

The channel CH3 stores Web data files constituting the contents of the channel CH3 at its root directory, and includes an image folder (IMAGES) which stores image data used by the Web data files, a sound data folder (SOUNDS) which stores sound data of sounds, music, and the like used by the Web data files, a client agent folder which stores client agent files provided for executing the special process, and used when a logon process for logon to the channel CH3 is started. The channel CH3 further includes an agent service folder which stores client service files used for executing the special process. The received data folder stores data the distribution control section 8 receives from the operation center, and the TEMP folder is used for decompressing compressed data.

Next, a content-receiving operation carried out by the distribution control section 8 and the content manager section 12 for receiving contents transmitted from the operation center 3 to the server 10 will be described hereinafter with reference to FIG. 3B.

The server 10 shown in FIG. 2 starts the distribution control section 8, for example, at the start of business operations every morning, and receives contents from the operation center 3 via the network 1. The operation center 3 distributes distributable data items of all the channels to a large number of servers 10 connected to the network 1. In this case, the operation center 3 may distribute to each server only channel data requested by the server. If distributable data items of all the channels are distributed, the operation center 3 need not carry out the process for selecting channels to which data items should be distributed, and so forth.

The distribution control section 8 of the server 10 receives data items of all the channels, and stores the same in the received data folder in a step S1. Then, the content manager section 12 looks up the content distribution-designating data 81 in a step S2. The content distribution-designating data 81 stores data items for designating channels, such as channel 1, channel 3, and channel 4, via which the server intends to provide information. The content manager section 12 selects data items of designated contents from data items stored in the received data folder to decompress the same in a step S3. Further, the content manager section 12 carries out in a step S4 a process for converting the decompressed data items to a data format suitable for display on the Web pages and a process for producing the category list 15. Then, in a step S5, the content manager section 12 stores the contents in the respective dedicated folders of the storage device 11. By carrying out the above process, the contents of a channel designated in advance are readably stored in the storage device 11 of the server 10.

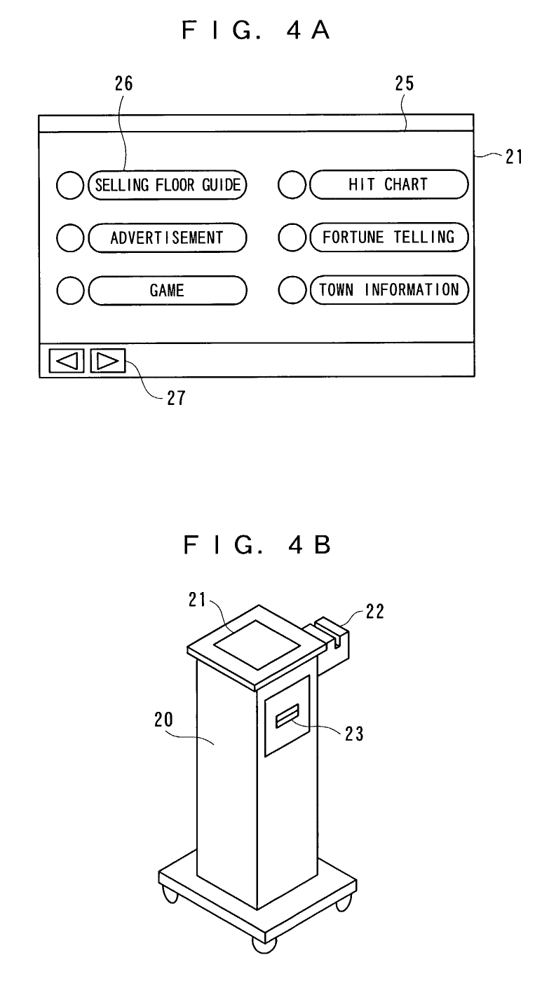

FIG. 4A is a diagram useful in explaining an example of a selection screen for use in selecting a channel. FIG. 4B is a perspective view showing the appearance of the information terminal.

As shown in FIG. 4B, the information terminal 4 has a display 21 arranged on a top surface of a body 20. Further, the information terminal 4 has a card reader 22 attached to a right-side surface of the body 20 as viewed in the figure, and a printer 23 attached to a front surface of the body as viewed in the figure. The card reader 22 is used e.g. for reading membership cards and credit cards. The printer 23 is used, for example, for printing information displayed on the display 21, and issuing coupons and point cards. As described above, the information terminal 4 can be provided with interfaces for operating devices, such as a card reader, a printer, and the like. On the display 21, the channel selection screen 25 as shown in FIG. 4A is displayed when the information terminal 4 is started. The channel selection screen 25 displays titles of the contents of the channels at channel display portions 26, respectively.

On the channel display portion 26, respective titles of the channels, brief descriptions of the contents of the channels, and symbolic icons for the channels may be freely displayed. Buttons 27 are operated for switching a channel selection screen to another. The channel selection screen 25 displayed on the display 21 of the information terminal 4 is generated by the content manager section 12. The content manager section 12 decompresses content data compressed on a channel-by-channel basis and received from the operation center 3, and transfers the same to the storage device 11.

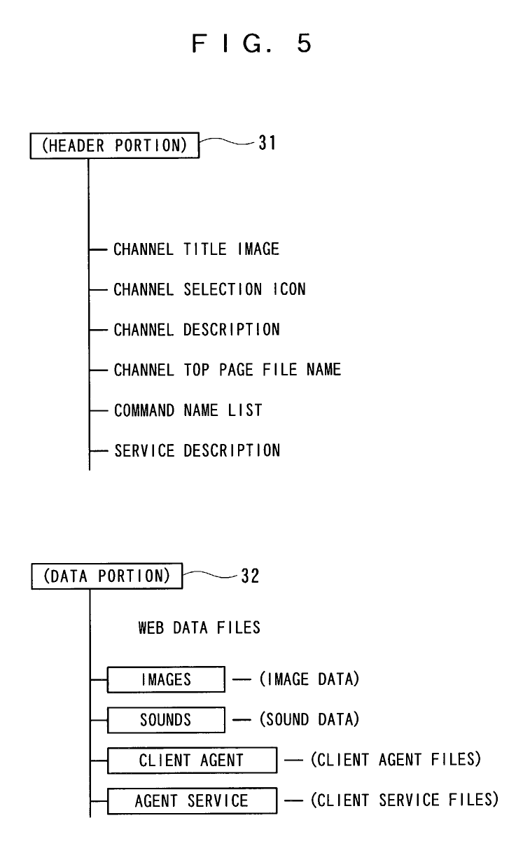

FIG. 5 is a diagram useful in explaining the construction of a content file to be distributed to each channel. The content data of the channel is comprised of a header portion 41 and a data portion 42. The header portion 41 includes data files of a channel title image, a channel selection icon, channel description, a top page file name of the channel, a command name list, service description, and so forth. Further, the data portion 42 includes Web data files and ancillary files attached thereto which have the same directory structure as that of the dedicated folders of the channel, described above with reference to FIG. 3A. When a data item compressed in the above state is distributed from the operation center, the content manager section 12 decompresses the data and transfers the decompressed data files to the storage device 11.

At this time, information to be displayed on the channel selection screen 25 is obtained from the header portion 41. The channel title image is used for the title of the channel. Further, the channel selection icon and channel description are added thereto. It should be noted that the channel top page file name represents a data file of a screen displayed first after selection of the channel. Further, since the channels are completely independent of each other, it is possible to use a command peculiar to each channel. Even if the same command name is added between channels, it is also possible to cause the channels to perform different operations from each other. Such commands are denoted in the command name list. The list of services provided on a channel-by-channel basis is shown in the service description. The above format enables each information terminal to designate and receive contents of a desired channel in an arbitrary sequence, to automatically generate a selection screen for selecting any of the corresponding channels and further enables a user to log in by using an original start screen of each channel.

In other words, if information of the content distribution-designating data 81 is changed, it is possible to freely increase, change, and decrease contents stored in the storage device 11 as desired, irrespective of which content is assigned to which channel. The server 10 is capable of dynamically generating a channel selection screen 25 as shown in FIG. 4A whenever the server 10 is started, and optimizing the channel selection screen 25.

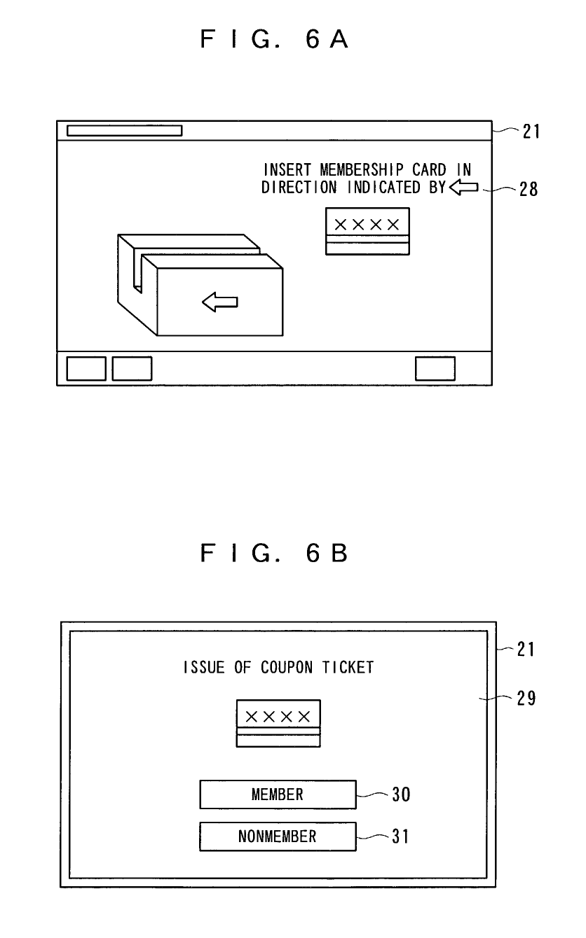

FIG. 6A shows an example of an operation screen 28 displayed on the information terminal when the terminal performs a card authentication process. FIG. 6B shows an example of an operation screen 29 displayed on the information terminal when the terminal performs a coupon ticket issuing process.

First, the first channel includes a content of service provided to only limited members. In this case, the operation screen 28 is displayed and the user is requested to insert a membership card into the card reader 22 (see FIG. 4B). When the user or member has inserted the card into the card reader 22, the information of the card is read and a personal identification process is carried out to identify the user. Further, as shown in FIG. 6B, to provide the service of displaying a shopping guide for a user who is shopping, or the service of issuing a coupon ticket to a user, the operation screen 29 is displayed.

When the user has membership, a coupon ticket with a special privilege added thereto is issued if he clicks a button 30 on the operation screen 29. Further, when the user does not have membership, a general coupon ticket is issued if he clicks a button 31. The above control operations allow the contents to be used by various means depending on the user's purposes, and further, it becomes possible to enable each user to use a desired one of functions provided in the information terminal 4 depending on the details of the contents, to thereby make use of the contents in various forms through communications between the information terminal 4 and the server 10.

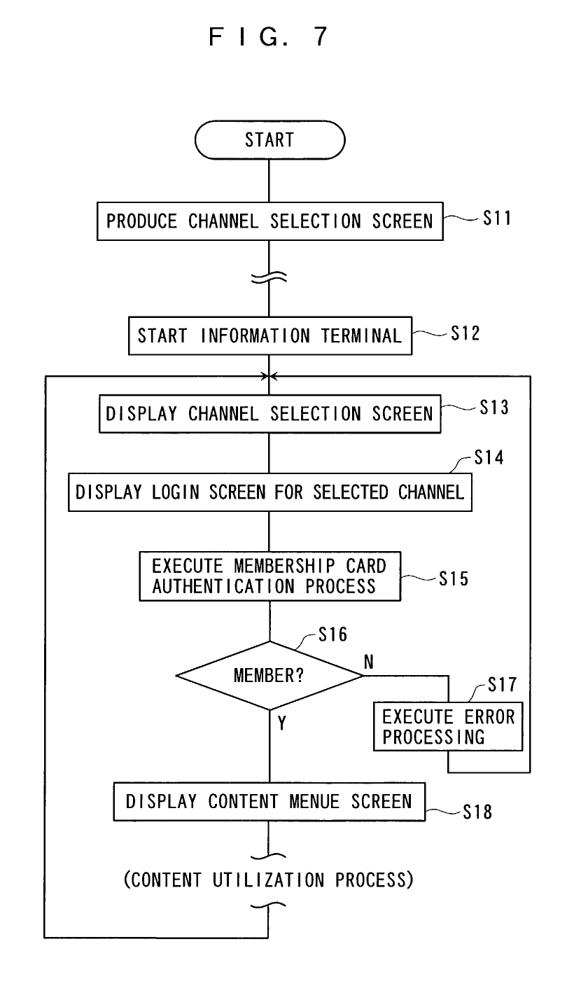

FIG. 7 is a flowchart showing operations carried out by the system configured as above when the information terminal 4 is operated.

First, in a step S11, when the server 10 is started, a channel selection screen is generated by the content manager section 12 in the manner already described hereinabove. Then, after the contents of all the channels have been stored in the storage device 11, the information terminal 4 is started in a step S12. The channel selection screen is displayed on the information terminal 4 in a step S13. Next, in a step S14, when the user selects a desired channel on the channel selection screen, a login screen for the selected channel is displayed. The login screen is, for example, a screen which requests the user to insert his card, as shown in FIG. 6A. In a step S15, information on the membership card inserted is read to carry out the authentication process. The card authentication process is executed e.g. by the agent service section 63 of the proxy server section 6, appearing in FIG. 2. In a step S16, it is determined whether or not the user has membership. If it is determined that the user has membership, a content menu screen is displayed in a step S18, and after that, the user is allowed to freely access and read the contents. Further, if it is determined that the user does not have membership, the program proceeds to a step S17, wherein error processing is carried out. Then, the program returns to the step S13 to display the channel selection screen. When the process for accessing the contents has been terminated, the program also returns to the step S13 to display the channel selection screen.

As described above, if the channels are constructed by groups of Web pages independent of each other on a channel-by-channel basis, and the server manages contents for channels such that the contents are distinguished and made independent from each other between channels, it becomes possible to realize content utilization systems completely different between channels, thereby enabling original contents to be freely designed on a channel-by-channel basis. This makes it possible to request a desired creator to design or provide contents for addition, modification, or deletion thereof. Further, it is possible to utilize contents of channels by storing menu screens and operation screens peculiar to the contents in respective dedicated folders therefor channel by channel. Further, this enables the server 10 to change channels contents of which are desired to be distributed, at any time. Additionally, if the channel selection screen is configured such that it can be dynamically and freely changed, each server can be customized with ease.

Further, if the system is configured such that the operation center 3 distributes data of all the channels at once, it is possible to dispense with management for distributing data in a peculiar fashion designated on a server-by-server basis, thereby simplifying system management. Furthermore, the information terminal is only required to have a simple construction capable of reading only Web data, and the operating system as well can be simplified in accordance with the simple construction of the information terminal. Therefore, it is possible to store the operating system and the browser in a flash memory having a relatively small capacity to start the information terminal quickly with ease.

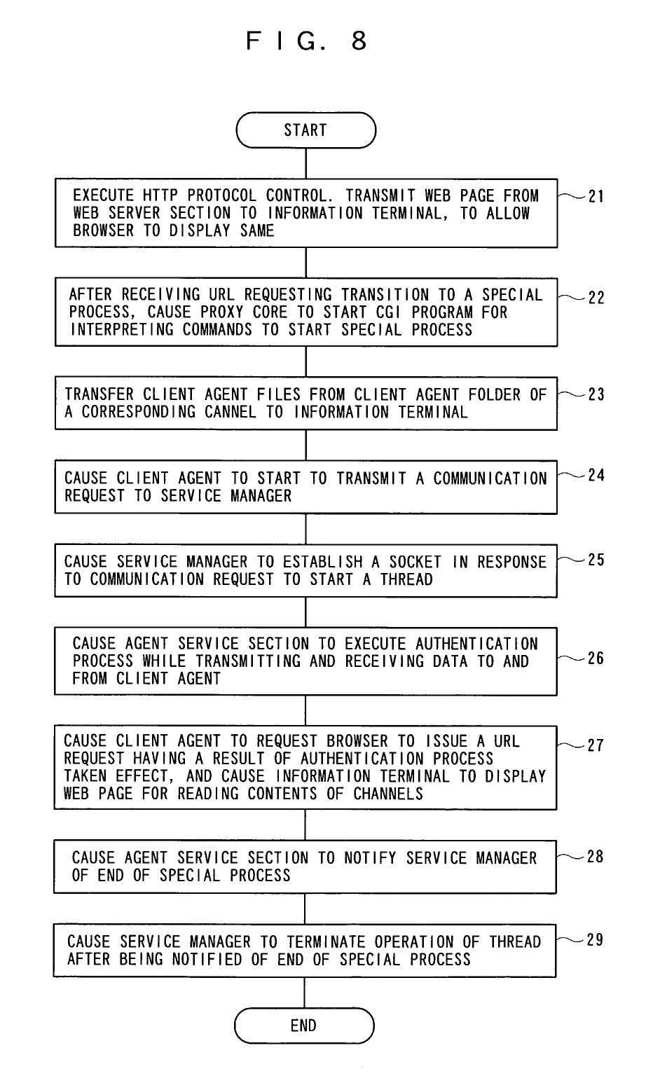

FIG. 8 is a flowchart which is useful in explaining operations carried out by the multimedia information system according to the present invention.

Steps in the figure correspond to S21 to S28 in FIG. 1, respectively. Therefore, identical step numbers are used in both of the figures to indicate the correspondence therebetween. The following description will be given with reference to FIGS. 8 and 1. As described hereinbefore, to reliably carry out the session control, the system realizes control for transition from a process under control by the HTTP protocol to a special process, and from the special process again to the process under control by the HTTP protocol. Further, during execution of the special process, transition to another process is inhibited until acquisition of required information has been completed.

First, during execution of the HTTP protocol control in the step S21, the proxy server section 6 passes a URL (Uniform Resource Locator) received from the information terminal 4, to the Web server section 5 to request a corresponding Web page to be read out from the storage device 11. Then, the Web page is transmitted from the Web server section 5 to the information terminal 4, and displayed on a display, not shown, of the information terminal 4 by the browser. Next, to request transition from a process under control by the HTTP protocol to a special process different from one under control of the HTTP protocol, the URL is used as command transfer means.

The URL has a format of (http://host name/(control folder name)/command), for example. In the step S22, when receiving the URL, the proxy core 61 embeds a partially dynamic parameter in an entity of a response as a response to a URL request having been automatically generated and prepared thereby in advance, which places the proxy core in a state for directly returning a response to the information terminal 4. This processing is referred to as “the redirect processing”. The proxy core 61 starts a program for interpreting commands stored in the control folder in the d drive appearing in FIG. 3A. This is the start of the special process. The program for interpreting commands interprets the above command by looking up a command reference table 64 in the proxy core 61. It should be noted that the command reference table 64 are downloaded and generated in the proxy core 61 when contents are distributed from the operation center 3 (see FIG. 2) in a predetermined timing.

When the command is interpreted to be a request for login to a predetermined channel and execution of an authentication process, a client agent file is transferred from the “client agent” folder of the corresponding channel (see FIG. 3A) to the information terminal 4 in a step S23. The client agent is written e.g. as a Java applet provided by Sun Microsystems, Inc. or a program operating on a Web browser described in a similar language. The client agent is started on the information terminal side to transmit a communication request to the service manager 62 in a step S24.

The service manager 62 establishes a socket in response to the communication request, and starts a program (agent service section 63) which is customized for a particular service and operates independently, in a step S25. After that, in a step S26, the agent service section 63 executes the authentication process while bi-directionally transmitting and receiving data to and from the client agent on the information terminal side. In the authentication process, for example, the agent service section 63 requests the user to input his member number and password, and carries out authentication to determine whether or not the user is the member himself. The client agent requests the browser to issue a URL request having the result of the authentication reflected therein in a step S27. For example, if it is determined that the user is a valid user, a Web page is displayed for allowing the user to read contents of the channel on the information terminal 4. When a sequence of processing steps have been terminated, the agent service section 63 notifies the service manager 62 of the termination in the step S28.

Upon reception of the notification, the service manager 62 terminates the operation of the program (agent service section 63) customized for the particular service and operating independently in a step S29. Thus, the special process is terminated, followed by resuming control by the HTTP protocol. It should be noted that the service manager 62 performs control such that transition to another process, such as a channel-switching process, is inhibited during execution of the authentication process by the client agent and the agent service section 63. More specifically, the service manager 62 inhibits the start of more than one agent service section. This makes it possible to carry out the session control reliably. Further, if the agent service section 63 as described above is customized channel by channel or task by task in advance, it is possible to carry out not only the login and authentication process but also other processes, such as the channel-switching process, a printing process, and so forth.

More specifically, the redirect processing mentioned above can be realized as follows. Upon reception of the URL including the command requesting transition to a special process, the proxy core 61 automatically generates a URL request, and returns a response to the client to requesting redirection to the URL of the generated URL request. Then, when receiving the URL request redirected from the client, the proxy core 61 responds to the URL request having been automatically generated and prepared in advance, without being relayed by the Web server. That is, the proxy core 61 causes the computer to carry out processing for returning to the client a response having a partially dynamic parameter embedded in an entity portion thereof, and containing a client agent file for executing the special process. The redirect processing is realized by a program which causes the computer to carry out the above operations. Further, the above system is capable of carrying out exclusive control such that a resident program for executing a special process, such as a channel-switching process, and a special process program for executing a special process to be started as occasion demands, such as a login and authentication process, are inhibited from being started or executed at the same time, and at the same time inhibiting interruption of the special process once started. If the system is configured as above, it is possible to prevent occurrence of a problem that is caused by the interruption of a session due to an interrupt handling routine or interruption of the program.

Further, the multimedia information system according to the present embodiment may be configured such that the operation center 3 is content distribution means for accumulating contents and distributing the same to each server via a network, and logon of an information terminal can be controlled by a simple program, such as the Java applet.

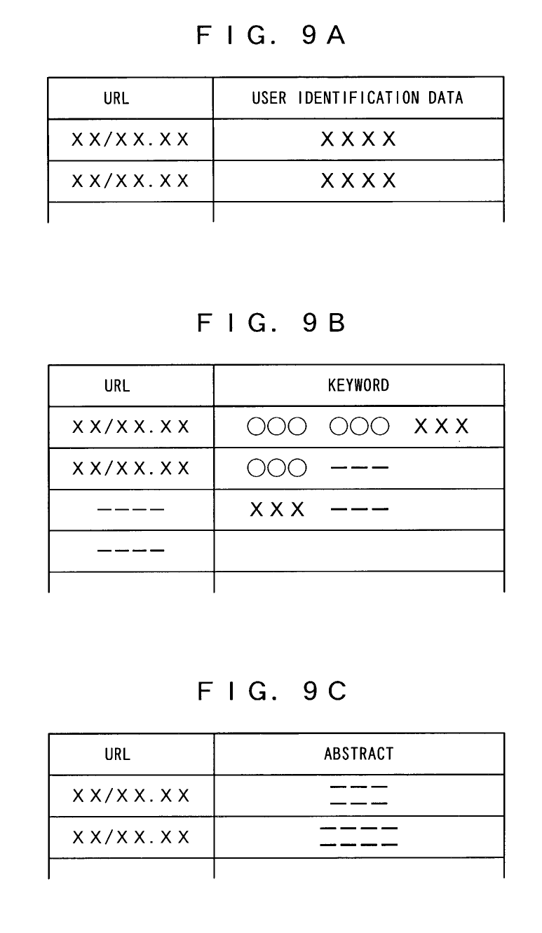

Next, a multimedia information system according to a second embodiment of the invention will be described with reference to FIG. 2, and FIGS. 9A to 12. The multimedia information system according to the present embodiment is distinguished from that of the first embodiment in that information of use of Web pages by users of information terminals is accumulated in the operation center 3 for utilization in various ways. It should be noted that the present embodiment is substantially identical to the first embodiment in the system itself, particularly in hardware thereof, and hence detailed description thereof is omitted.

FIGS. 9A to 9C are diagrams which are useful in explaining log data and category lists used in the multimedia information system according to the present embodiment. FIG. 9A shows an example of the log data, and FIGS. 9B and 9C show examples of the category lists.

As shown in FIG. 9A, when a request for reading any of the contents 17 is made via the information terminal 4 (see FIG. 2), the proxy core 61 of the proxy server section 6 (see FIG. 2) produces log data, as shown in FIG. 9A, in which user identification data is associated with the URL of a requested Web page. The log data can contain not only the URL and the user identification data but also a time when the user has read the corresponding Web page, an information terminal used by the user, and other information items. The log data is stored in the log data storage section 14 (see FIG. 2).

It should be noted that the system shown in FIG. 2 allows the contents of channels to be replaced with other contents as desired. More specifically, the server 10 can be operated while assigning a desired content to a desired channel. Therefore, it is impossible to confirm what kind of information each user has read, afterwards, only from information of which user read a Web page having which URL address. The same URL sometimes can provide a completely different Web page on different occasions. To eliminate these inconveniences, keywords or abstracts indicative of contents are included in advance in the category list 15 appearing in FIG. 2 in a manner associated with URLs. This category list 15 is produced by the content manager 12 appearing in FIG. 2.

The logging processor 16 (see FIG. 2) synthesizes the list (log data) in which URLs and user identification data are associated with each other, as described above, and stored in the log data storage section 14 (see FIG. 2), and the category list 15 in which URLs are associated with keywords or abstracts, to thereby produce information indicative of which user has read contents containing what keywords or abstracts. Then, the logging processor 16 transmits the information to the operation center 3. It should be noted that the logging processor 16 may transmit log data and the category list to the operation center 3 without further processing and the operation center 3 may produce information indicative of which user has read contents containing what keywords or abstracts. Further, it is preferable that the operation center 3 compiles the information or data to produce compiled information useful for business strategy and the like.

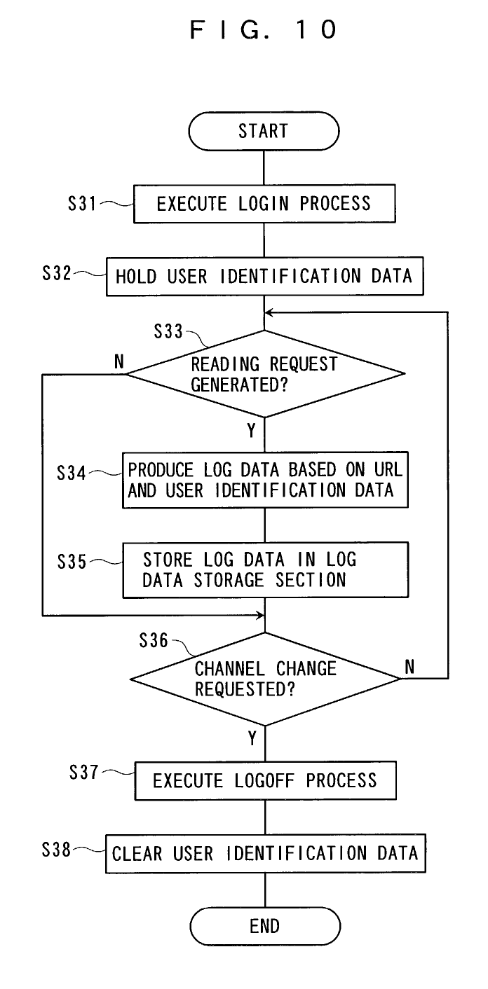

FIG. 10 is a flowchart showing operations for holding user identification data when a user logs in by the information terminal 4 (see FIG. 2).

Referring to the figure, first, a login process for the information terminal 4 is executed in a step S31. Next, in a step S32, the proxy core 61 (see FIG. 2) obtains a user code, a password, and the like input via the information terminal 4, and holds user identification information in a register, not shown. Any form of user identification information may be employed so long as it enables identification of the user. After the login process has been normally terminated, it is monitored in a step S33 whether or not a reading request is generated. When a reading request is generated, the program proceeds from the step S33 to a step S34, wherein log data is produced based on the URL of a requested Web page and the user identification data held in the register. Then, in a step S35, the log data is stored in the log data storage section 14. So long as the user is reading a Web page in the same channel, the step S33 to the step S35 are repeatedly carried out, and when a request for changing channels is detected in a step S36, the program proceeds to a step S37. If the request for changing channels has been made, a logoff process is carried out in the step S37. Next, in a step S38, the user identification data is cleared. That is, when the present channel is switched to another, another login process is executed by using the information terminal again. Therefore, the user identification data is obtained again when the login process is executed. After that, the processes from the step S33 to the step S38 are carried out again.

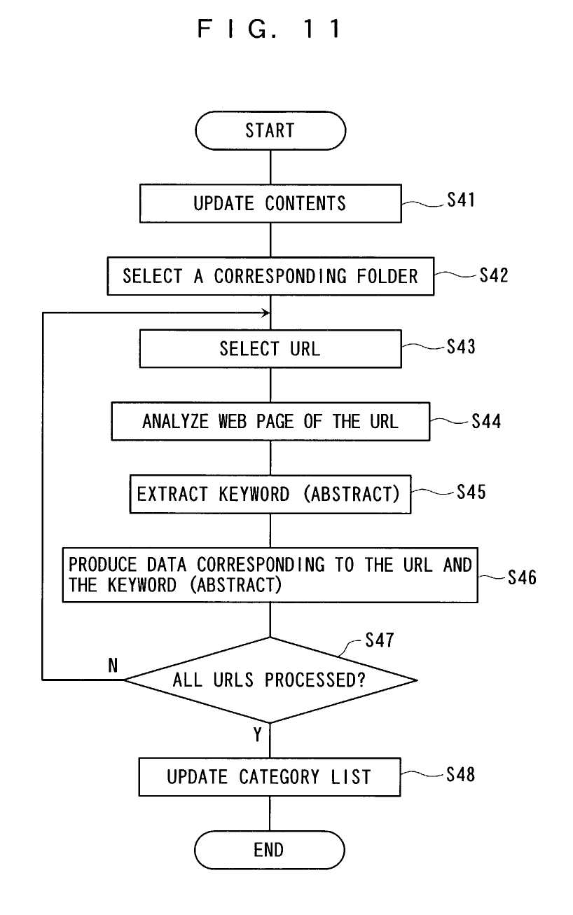

FIG. 11 is a flowchart showing a process for producing the category list 15 carried out by the content manager section 12.

The content manager section 12 updates a category list of contents 17 e.g. when new contents have been distributed to the storage device 11 (see FIG. 2), or when any of the contents 17 has been rewritten due to some cause. First, when some content has been distributed from the operation center 3 to the server 10 to update any of the contents 17 stored in the storage device 11 in a step S41, the content manager section 12 detects the renewal of the content 17, and selects a folder storing the corresponding content in a step S42. The content manager section 12 sequentially selects the URLs of all the Web pages to start a process for analyzing the Web pages. In a step S43, first, the content manager section 12 selects the URL of a first Web page, and analyzes the first Web page, in a step S44. Analysis of the Web pages includes, for example, a process carried out in a step S45 for extracting keywords contained in a predetermined portion of each Web page, or extracting an abstract therefrom. In a step S46, data in which URLs are associated with keywords or with abstracts, as shown in FIG. 9B or 9C, are produced. In a step S47, it is determined whether or not the Web pages of all the URLs have been processed. If the keyword-extracting process for all the updated contents has been completed, the program proceeds from the step S47 to a step S48, wherein the category list 15 is updated. The above processes are carried out immediately after the contents have been updated, whereby it becomes possible to produce information indicative of what kind of Web page is stored in which URL, and which Web page has been used by the user. It is preferred that immediately before updating the contents, the category list 15 and the log data which have already been produced before the updating are transmitted to the operation center 3. This is because when the category list 15 has been updated, a Web page having been read in the past can have been moved to a place having a different URL.

By carrying out the above processes, information of when and what Web page a user of each information terminal read is accumulated in the operation center 3. This information is analyzed from various angles in the operation center 3. Further, the information is also analyzed by traders concerned who have obtained the information from the operation center 3. Thus, for example, a supermarket or a convenience store can obtain information of how customers of the store utilized its information terminals, and what contents were read by them. This makes it possible to change, for example, articles exhibited in the store, or plans of articles to be sold from now on, such that they meet the user's needs. Further, as described above, it is possible to provide the information terminals 4 with a capability of providing various information items which are not necessarily related to articles exhibited in a convenience store or the like. Therefore, it is possible to enrich details of contents according to the users' liking and actual use of contents, thereby enhancing effects of attraction of customers.

Further, a user who uses the information terminal 4 desires to view contents he often utilizes, on the display of the information terminal 4 as quickly as possible. For example, if users can quickly open or view contents they usually read by using information terminals 4 in convenience stores they usually visit, the degree of utilization of the information terminals 4 must be increased. Therefore, a scheme is created for purposes of convenience of users based on information of use of contents, which is compiled on a user-by-user basis. For example, a history of Web pages having read by a specific user in the past is kept, and an environment enabling the Web pages to be viewed by the user as quickly as possible is constructed. If a list of URLs is formed in advance in which histories of reading contents are accumulated on a user-by-user basis, each user can use the list to browse his favorite page quickly.

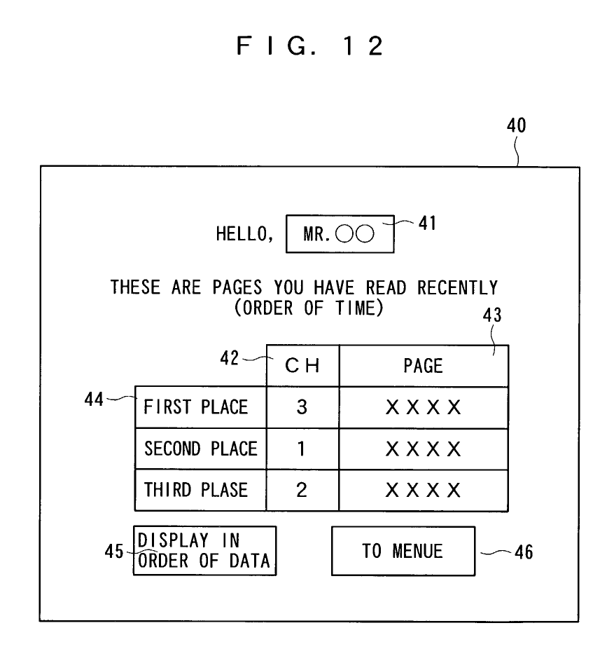

FIG. 12 is a diagram showing an example of a login screen which makes use of accumulated information for convenience of each user.

In the example illustrated in the figure, the login screen 40 includes an indication 41 notifying each user that this screen is exclusively provided for the user. The indication 41 contains the name of each user. Further, the indication 41 displays a list of channels 42 the user has browsed recently, and URLs 43 of Web pages the user has read in the channels. The illustrated list shows the channels and Web pages in decreasing order of the length of time over which the channels and pages were read. The user can know the channel or page which he has made most of recently, by the order 44. Thus, as the user uses the information terminal more frequently, he is automatically provided with an environment making it easier for him to make use of contents. It should be noted that the login screen 40 further includes a button 45 for switching between methods of displaying the list, and a button 46 for switching the login screen 40 to a general-type menu screen for displaying a menu of contents. In the illustrated example, a page which was read by the user for the longest time period is set to a first place and Web pages are shown in decreasing order of length of time over which the pages were read. However, it is also possible to employ a method in which a page read by the user most recently is set to a first place with highest preference given thereto. It should be noted that when a portion of the URLs 43 in the login screen 40 is clicked, a corresponding page can be directly displayed, thereby enhancing the operability of the terminal. If it is difficult to grasp the details of the corresponding Web page only from the URLs, the keyword and title of the corresponding page may be displayed together with the URL 43.

The servers as described hereinabove are arranged e.g. in main stores of a convenience store chain such that each store has at least several information terminals installed therein. The operation center 3 periodically and automatically collects log data from each server, automatically grasps the users' liking and use of contents based on the accumulated information, and optimizes contents to be distributed to the server. This makes it possible to construct a multimedia information system which dispenses with maintenance of the servers in each store, and is at the same time capable of grasping the needs of customers with a large customer pulling power. Further, as shown in the example described above with reference to FIG. 2, if the system is adopted in which dedicated information terminals 4 are connected to the server 10 to allow users to make use of contents, it is possible to carry out a login process for requesting each of all the users to input his user code, thereby automatically accumulate information what contents each of all the users makes use of without exception. Therefore, the data accumulated as above can be effectively utilized as various business information items.

It should be noted that, as described above, the function blocks or sections of the server 10 shown in FIG. 2 may be constructed by separate program modules, or alternatively they may be constructed by program modules integrally formed with each other. All or part of the function blocks or sections may be formed by hardware implemented by logical circuits. Further, each program module may be operated by being incorporated in an existing application program, or may be operated as an independent program. A computer program realizing the invention as described above can be recorded in a computer-readable recording medium, such as a CD-ROM, and put into use by installing the same in a computer. Further, the computer program can downloaded in the memory of a computer through a network to use it.

It is further understood by those skilled in the art that the foregoing is a preferred embodiment of the invention, and that various changes and modifications may be made without departing from the spirit and scope thereof.

What is claimed is:

1. A multimedia information system comprising:
an information terminal;
a Web server section responsive to a request made by a browser on said information terminal, for selecting a Web page contained in contents to allow the Web page to be read; and
a proxy server section between said information terminal and said Web server section, for controlling said information terminal,
wherein when a URL including a command requesting transition to a special process is input from said browser on said information terminal to said proxy server section, said proxy server section interprets the command by using command-interpreting means to carry out the special process.

2. A multimedia information system according to claim 1, wherein the special process is carried out according to a protocol different from an HTTP protocol.

3. A multimedia information system according to claim 1, wherein in the special process, control is carried out for inhibiting transition to another process until acquisition of required information has been completed.

4. A multimedia information system according to claim 1, wherein the URL including the command requesting transition to the special process comprises a URL portion indicative of a site storing a command-interpreting program, and a command portion indicating a command corresponding to the requested special process as a parameter.

5. A multimedia information system according to claim 4, wherein when said proxy server section receives the URL including the command requesting transition to the special process, said proxy server section executes a redirect processing for returning a response having a partially dynamic parameter embedded in an entity portion thereof and containing files of a client agent, to said information terminal, as a response to a URL request having been automatically generated and prepared in advance.

6. A multimedia information system according to claim 5, wherein said proxy server section establishes a socket in response to a communication request made by the client agent on said information terminal, starts part of a program provided in advance for independent operation, and executes a process for a particular service while bi-directionally transmitting and receiving data to and from the client agent.

7. A multimedia information system according to claim 6, wherein said proxy server section carries out exclusive control for inhibiting a plurality of special processes from being started simultaneously, and at the same time inhibits interruption of the special process once started.

8. A multimedia information system according to claim 6, wherein said proxy server section customizes the part of the program provided in advance for independent operation as the particular service on a channel-by-channel basis.

9. A multimedia information system according to claim 6, wherein commands peculiar to respective channels are set on a channel-by-channel basis.

10. A computer program for a network including a Web server section responsive to a request made by a browser on an information terminal, for selecting a Web page contained in contents to allow the Web page to be read, and a proxy server section between said information terminal and said Web server section, for controlling said information terminal,
the computer program causing, when a URL including a command requesting transition to a special process is input from said browser on said information terminal to said proxy server section, a computer of a server to carry out the special process by interpreting the command by using command-interpreting means.

11. A computer program according to claim 10, wherein the special process is carried out according to a protocol different from an HTTP protocol.

12. A computer program according to claim 10, wherein the computer program causes said computer of said server to carry out control for inhibiting transition to another process until acquisition of required information has been completed, in the special process.

13. A computer program according to claim 10, wherein the URL including the command requesting transition to the special process comprises a URL portion indicative of a site storing a command-interpreting program, and a command portion indicating a command corresponding to the requested special process as a parameter.

14. A computer program according to claim 13, wherein the computer program causes, when the URL including the command requesting transition to the special process is received from a network side, said computer of said server to carry out processing for executing a redirect processing for returning a response having a partially dynamic parameter embedded in an entity portion thereof and containing files of a client agent to said network side, as a response to the URL request having been automatically generated and prepared in advance.

15. A computer program according to claim 14, wherein the computer program causes said computer of said server to carry out processing for establishing a socket in response to a communication request made by the client agent on said network side, starting part of a program provided in advance for independent operation, and executing a process for a particular service including an authentication process while bi-directionally transmitting and receiving data to and from the client agent.

16. A computer program according to claim 15, wherein the computer program causes said computer of said server to carry out exclusive control for inhibiting a plurality of special process from being started simultaneously, and at the same time to perform processing for inhibiting interruption of the special process once started.

17. A computer program according to claim 16, wherein the computer program causes said computer of said server to carry out processing for customizing the part of the program provided in advance for independent operation as the particular service on a channel-by-channel basis.

18. A computer program according to claim 10, wherein the computer program causes said computer of said server to carry out processing for setting commands peculiar to respective channels on a channel-by-channel basis.

19. A computer program for causing a computer of a server to carry out:
processing for causing a Web server section to select a Web page contained in contents to allow the Web page to be read in response to a request input via a network,
processing for causing a proxy server section to respond to a predetermined URL-based request entered via said network, and
processing for causing said proxy server section to interpret a command by using command-interpreting means to execute a special process, when a URL including the command requesting transition to the special process is input to said proxy server section via said network.

20. A computer program for causing a computer of a server to carry out processing for selecting a Web page contained in contents to allow the Web page to be read in response to a request input via a network, and
processing for responding to a predetermined URL-based request entered via said network, and
wherein the computer program causes, when a URL including a command requesting transition to a special process is input to a proxy server section via said network, said computer of said server to execute the special process for causing said proxy server section to interpret the command by using command-interpreting means to thereby handle the URL.

21. A multimedia information system including a Web server section for selecting a Web page contained in contents to allow the Web page to be read via a network, and a proxy server section directly connected to said network,
wherein when a URL including a command requesting transition to a special process is input to said proxy server section via said network, said proxy server section interprets the command by using command-interpreting means, and executes the special process.

22. A multimedia information system according to claim 21, wherein the special process is carried out according to a protocol different from an HTTP protocol.

23. A multimedia information system according to claim 21, wherein in the special process, control is carried out for inhibiting transition to another process until acquisition of required information has been completed.

24. A multimedia information system according to claim 21, wherein the URL including the command requesting transition to the special process comprises a URL portion indicative of a site storing a command-interpreting program, and a command portion indicating a command corresponding to the requested special process as a parameter.

25. A multimedia information system according to claim 24, wherein when said proxy server section receives the URL including the command requesting transition to the special process from a network side, said proxy server section executes a redirect processing for returning a response having a partially dynamic parameter embedded in an entity portion thereof and containing files of a client agent to said network side, as a response to the URL request having been automatically generated and prepared in advance.

26. A multimedia information system according to claim 25, wherein said proxy server section establishes a socket in response to a communication request made by the client agent on said network side, starts part of a program provided in advance for independent operation, and executes a process for a particular service while bi-directionally transmitting and receiving data to and from the client agent on said network side.

27. A multimedia information system according to claim 26, wherein said proxy server section carries out exclusive control for inhibiting a plurality of special process from being started simultaneously, and at the same time inhibits interruption of the special process once started.

28. A multimedia information system according to claim 26, wherein said proxy server section customizes the part of the program provided in advance for independent operation as the particular service on a channel-by-channel basis.

29. A multimedia information system according to claim 26, wherein commands peculiar to respective channels are set on a channel-by-channel basis.

30. A multimedia information system comprising:
content distribution means; and
a server connected to said content distribution means via a network,
wherein contents stored in said server are formed by groups of Web pages such that the groups are independent of each other and provided on a channel-by-channel basis, and
wherein said server designates contents by channel and receives contents of a designated channel distributed by said content distribution means in a predetermined timing.

31. A multimedia information system comprising:
content distribution means;
a server connected to said content distribution means via a network; and
information terminals for utilizing contents stored in said server,
wherein the contents are formed by groups of Web pages such that the groups are independent of each other and provided on a channel-by-channel basis, and
wherein said server designates contents by channel and receives contents of a designated channel distributed by said content distribution means in a predetermined timing.

32. A multimedia information system according to claim 30, wherein when said server receives data of the contents of the designated channel distributed from said content distribution means, said server produces a channel selection screen based on information contained in the distributed data.

33. A multimedia information system according to claim 31, wherein each information terminal displays the channel selection screen after a start thereof, and
wherein when any channel is selected by operation on the channel selection screen, said information terminal displays a start screen or login screen for the selected channel.

34. A multimedia information system according to claim 30, wherein said content distribution means automatically distributes contents designated by channel to a large number of servers via said network in the predetermined timing.

35. A multimedia information system according to claim 30, wherein said content distribution means automatically distributes contents via said network based on content distribution-designating data stored in a predetermined storage area of said server.

36. A multimedia information system according to claim 30, wherein said server selects contents designated by the content distribution-designating data from the contents distributed via said network, and stores the selected contents in dedicated folders therefor on a channel-by-channel basis.

37. A multimedia information system according to claim 30, wherein contents of each channel distributed by said content distribution means are stored separately in a dedicated folder therefor in said server.

38. A multimedia information system according to claim 37, wherein attribute data for use in displaying the selection screen is distributed from said content distribution means to said dedicated folder.

39. A multimedia information system according to claim 38, wherein said attribute data distributed to said dedicated folder for use in displaying the channel selection screen includes information containing description of contents peculiar to each channel.

40. A multimedia information system according to claim 30, wherein whenever contents of each channel are distributed, said server produces a channel selection screen for selection of any of all usable channels, based on the information added to the contents distributed.

41. A multimedia information system according to claim 31, wherein said server includes a storage device, and selects contents designated by content distribution-designating data from the contents distributed via said network and stores the selected contents in dedicated folders therefor on a channel-by-channel basis, attribute data for use in displaying the selection screen being distributed from said content distribution means to each of said folders, said server producing data of the channel selection screen and storing the produced data in said storage device, and
wherein each information terminal, after a start thereof, reads out the data of the channel selection screen from said storage device of said server to display the channel selection screen.

42. A multimedia information system according to claim 30, wherein the contents are distributed as units independent of each other, for respective channels, and
wherein said respective channels serve as imaginary Web sites independent of each other on said server.

43. A multimedia information system according to claim 31, wherein each information terminal, after being switched on, automatically starts a browser to display the channel selection screen.

44. A computer program for causing a computer controlling content distribution means to carry out processing for automatically distributing, via a network, contents formed by groups of Web pages such that the groups are independent of each other and provided on a channel-by-channel basis, for storage in a server connected to said content distribution means via said network, based on content distribution-designating data stored in a predetermined storage area of said server.

45. A computer program for causing a computer controlling a server to carry out processing for designating contents formed by groups of Web pages such that the groups are independent of each other and provided on a channel-by-channel basis, by channel, to receive contents of a designated channel distributed from a content-distributing side in a predetermined timing, for storage in said server.

46. A computer program according to claim 45, wherein when said server receives data of the contents of the designated channel distributed from a content-distributing side, the computer program causes said computer controlling said server to carry out processing for producing a channel selection screen based on information contained in the distributed data.

47. A computer program according to claim 45, wherein the computer program causes a computer for content distribution means to carry out processing for automatically distributing the contents designated by channel to a large number of servers via a network in a predetermined timing.

48. A computer program according to claim 45, wherein the computer program causes said computer controlling said server to carry out processing for selecting contents designated by content distribution-designating data from the contents distributed via said network, and storing the selected contents in respective dedicated folders therefor on a channel-by-channel basis.

49. A computer program according to claim 45, wherein the computer program causes said computer controlling said server to carry out processing for storing the contents of each channel distributed by said content distribution means separately in a dedicated folder therefor in said server.

50. A computer program according to claim 45, wherein the computer program causes said computer controlling said server to carry out processing for having attribute data distributed from said content distribution means to each folder, for use in displaying the selection screen.

51. A computer program according to claim 45, wherein the computer program causes said computer controlling said server to carry out processing for causing information including description of contents peculiar to each channel to be included in said attribute data distributed to said dedicated folder, for use in displaying the selection screen.

52. A computer program according to claim 45, wherein the computer program causes said computer controlling said server to carry out processing for producing a channel selection screen for selection of any of all usable channels, based on the information added to the contents of said each channel whenever the contents are distributed.

53. A multimedia information system comprising a server connected to a content-distributing side via a network,
wherein contents stored in said server are formed by groups of Web pages such that the groups are independent of each other and provided on a channel-by-channel basis, and
wherein said server designates contents by channel and receives contents of a designated channel distributed from said content-distributing side in a predetermined timing.

54. A multimedia information system comprising:
a server connected to a content-distributing side via a network; and
information terminals for utilizing contents stored in said server,
wherein the contents are formed by groups of Web pages such that the groups are independent of each other and provided on a channel-by-channel basis, and
wherein said server designates contents by channel and receives contents of a designated channel distributed from said content-distributing side in a predetermined timing.

55. A multimedia information system according to claim 53, wherein when said server receives data of the contents of the designated channel distributed from said content-distributing side, said server produces a channel selection screen based on information contained in the distributed data.

56. A multimedia information system according to claim 54, wherein each information terminal displays the channel selection screen after a start thereof, and
wherein when any channel is selected by operation on the channel selection screen, a start screen or login screen for the selected channel is displayed.

57. A multimedia information system according to claim 53, wherein said server receives the contents of the designated channel automatically distributed in a predetermined timing from said content-distributing side via said network.

58. A multimedia information system according to claim 53, wherein said content-distributing side includes content distribution means for automatically distributing contents via said network based on content distribution-designating data stored in a predetermined storage area of said server.

59. A multimedia information system according to claim 53, wherein said server selects contents designated by said content distribution-designating data from the contents distributed via said network, and stores the selected contents in respective dedicated folders therefor on a channel-by-channel basis.

60. A multimedia information system according to claim 53, wherein contents of each channel distributed by said content distribution means are stored separately in a dedicated folder therefor in said server.

61. A multimedia information system according to claim 60, wherein attribute data for use in displaying the channel selection screen is distributed from said content distribution means to said dedicated folder.

62. A multimedia information system according to claim 61, wherein said attribute data distributed to said dedicated folder, for use in displaying the channel selection screen, includes information containing description of contents peculiar to each channel.

63. A multimedia information system according to claim 53, wherein whenever the contents of each channel are distributed, said server produces a channel selection screen for selection of any of all usable channels, based on the information added to the contents distributed.

64. A multimedia information system according to claim 54, wherein said server includes a storage device, and selects contents designated by content distribution-designating data from the contents distributed via said network and stores the selected contents in dedicated folders therefor on a channel-by-channel basis, attribute data being distributed from said content distribution means to each of said folders, for use in displaying the channel selection screen, said server producing data of the channel selection screen and storing the produced data in said storage device, and
wherein each information terminal, after a start thereof, reads out the data of the channel selection screen from said storage device of said server to display the channel selection screen.

65. A multimedia information system according to claim 54, wherein the contents are distributed as units independent of each other, for respective channels, and
wherein said respective channels serve as imaginary Web sites independent of each other on said server.

66. A multimedia information system according to claim 54, wherein each information terminal, after being switched on, automatically starts a browser to display the channel selection screen.

67. A multimedia information system including a server for allowing contents to be read via a network for utilization thereof,
wherein said server comprises means for generating and storing log data which contains user identification data for identifying users utilizing the contents and URLs of read Web pages.

68. A multimedia information system including a server, and an information terminal for making use of contents stored in said server, and
wherein said server comprises means for generating and storing log data which contains user identification data input by operating said information terminal and URLs of Web pages reading of which was requested by said information terminal.

69. A multimedia information system according to claim 67, wherein said server acquires the user identification data during execution of a login process when a group of contents starts to be read.

70. A multimedia information system according to claim 68, wherein said server acquires the user identification data when said information terminal logs in.

71. A multimedia information system according to claim 67 or 68, wherein said server includes a storage device, and produces and holds a category list in which a URL of each Web page stored in said storage device of said server for being read and a keyword contained in the each Web page are associated with each other.

72. A multimedia information system according to claim 67 or 68, wherein said server includes a storage device, and a content manager that extracts a keyword from each Web page newly stored in said storage device for being read, and produces a category list in which a URL of the each Web page and the keyword contained in the each Web page are associated with each other.

73. A multimedia information system according to claim 67 or 68, wherein said server includes a storage device, and a content manager that extracts an abstract from a predesignated portion of each Web page newly stored in said storage device for being read, and produces a category list in which a URL of the each Web page and the abstract in the each Web page are associated with each other.

74. A multimedia information system according to claim 67 or 68, wherein said server includes a storage device, and stores contents formed by groups of Web pages such that the groups are independent of each other and provided on a channel-by-channel basis, in dedicated folders of said storage device, respectively, and
wherein said server includes a proxy server section for executing a login process for each channel, and holding user identification data input during execution of the login process until logoff from said channel.

75. A multimedia information system according to claim 68, wherein said information terminal displays a channel selection screen after a start thereof, and when any channel is selected by operation on the channel selection screen, said information terminal displays a login screen for login to said any channel.

76. A multimedia information system according to claim 67 or 68, including content distribution means for automatically distributing contents designated by channel to a large number of servers via a network in a predetermined timing.

77. A multimedia information system according to claim 76, wherein said server transmits the log data to said content distribution means via said network in a predetermined timing.

78. A multimedia information system according to claim 76, wherein said server transmits the log data and the category list in which the URL of the each Web page and the keyword contained in the each Web page are associated with each other to said content distribution means via said network in a predetermined timing.

79. A multimedia information system according to claim 76, wherein said content distribution means includes means for producing accumulated information in which user identification information of all users using said server and keywords of Web pages read by any of the users are associated with each other, based on the user identification information contained in the log data transmitted from said server, the URLs contained in the category list, and the keywords contained in the Web pages.

80. A multimedia information system according to claim 76, wherein said content distribution means includes means for producing accumulated information in which user identification information of all users using said server and abstracts of Web pages read by any of the users are associated with each other, based on the user identification data contained in the log data transmitted from said server, the URLs contained in the category list, and the abstracts contained in the Web pages.

81. A multimedia information system according to claim 79 or 80, wherein said content distribution means includes means for analyzing the accumulated information to extract a tendency of use of contents on a server-by-server basis, and producing content selection information for being distributed to each server.

82. A multimedia information system according to claim 79 or 80, wherein said content distribution means includes means for analyzing the accumulated information to extract a tendency of use of contents on a user-by-user basis, and producing content selection information to be distributed to each server.

83. A multimedia information system according to claim 79 or 80, wherein when said server acquires the user identification information of a user in the login process, said server produces and displays a dedicated menu screen for the user based on the accumulated information.

84. A computer program for causing a computer of a server for allowing contents to be read via a network for utilization thereof, to carry out processing for producing and storing log data which contains user identification data of users utilizing the contents and URLs of read Web pages.

85. A computer program for causing a computer of a server allowing contents to be read and utilized by an information terminal to carry out processing for producing and storing log data which contains user identification data input by operation on said information terminal and URLs of Web pages reading of which was requested by said information terminal.

86. A computer program according to claim 84, wherein the computer program causes said computer of said server to carry out processing for acquiring the user identification data during execution of a login process when a group of contents starts to be read.

87. A computer program according to claim 85, wherein the computer program causes said computer of said server to carry out processing for acquiring the user identification data when said information terminal logs in.

88. A computer program according to claim 84 or 85, wherein said server includes a storage device, and wherein the computer program causes said computer of said server to carry out processing for producing and holding a category list in which a URL of each Web page stored in a storage device of said server for being read, and a keyword contained in the each Web page are associated with each other.

89. A computer program according to claim 84 or 85, wherein said server includes a storage device, and wherein the computer program causes said computer of said server to carry out processing for extracting a keyword from each Web page newly stored in said storage device for being read, and producing a category list in which a URL of the each Web page and the keyword contained in the each Web page are associated with each other.

90. A computer program according to claim 84 or 85, wherein said server includes a storage device, and the computer program causes said computer of said server to carry out processing for extracting an abstract from a predesignated portion of each Web page newly stored in said storage device for being read, and producing a category list in which a URL of the each Web page and the abstract in the each Web page are associated with each other.

91. A computer program according to claim 84 or 85, wherein said server includes a storage device, and wherein the computer program causes said computer of said server to carry out processing for storing contents formed by groups of Web pages such that the groups are independent of each other and provided on a channel-by-channel basis in respective dedicated folders of said storage device, executing a login process for each channel, and holding user identification data input during execution of the login process until logoff from said channel.

92. A computer program for causing a computer of a server allowing contents to be read and utilized by an information terminal to carry out processing for producing and storing log data which contains user identification data input by operation on said information terminal and URLs of Web pages reading of which was requested by said information terminal, and
wherein the computer program causes, when said information terminal displays a channel selection screen containing the contents after a start thereof, and any channel is selected by operation on the channel selection screen, a login screen of a selected channel to be displayed on said information terminal.

93. A computer program according to claim 84 or 85, wherein the computer program causes said computer of said server to carry out processing for automatically receiving contents designated by channel in a predetermined timing via said network.

94. A computer program according to claim 93, wherein the computer program causes said computer of said server to carry out processing for transmitting the log data to content distribution means in a predetermined timing via said network.

95. A computer program according to claim 93, wherein the computer program causes said computer of said server to carry out processing for transmitting the log data and the category list in which the URL of each Web page and the keyword contained in the each Web page are associated with each other to content distribution means via said network in a predetermined timing.

96. A computer program for causing, after a server allowing contents to be read via a network for utilization thereof carries out processing for producing and storing log data which contains user identification data of users utilizing the contents and URLs of read Web pages, a computer of content distribution means to carry out processing for producing accumulated information in which user identification information of all users using said server and keywords of Web pages read by any of the users are associated with each other, based on the user identification information contained in the log data transmitted from said server, the URLs contained in the category list, and the keywords contained in the Web pages.

97. A computer program for causing, after a server allowing contents to be read via a network for utilization thereof, carries out processing for producing and storing log data which contains user identification data of users utilizing the contents and URLs of read Web pages, a computer of content distribution means to carry out processing for producing accumulated information in which user identification information of all users using said server and abstracts of Web pages read by any of the users are associated with each other, based on the user identification data contained in the log data transmitted from said server, the URLs contained in the category list, and the abstracts contained in the Web pages.

98. A computer program according to claim 96 or 97, wherein the computer program causes said computer of said content distribution means to carry out processing for analyzing the accumulated information to extract a tendency of use of contents on a server-by-server basis, and producing content selection information to be distributed to each server.

99. A computer program according to claim 96 or 97, wherein the computer program causes said computer of said content distribution means to carry out processing for analyzing the accumulated information to extract a tendency of use of contents on a user-by-user basis, and producing content selection information to be distributed to each server.

100. A computer program for causing a computer of a server allowing contents to be read via a network for utilization thereof, to carry out:
processing for producing and storing log data which contains user identification data of users utilizing the contents and URLs of read Web pages, and
processing for producing and displaying a dedicated menu screen for a user, after user identification information of the user has been acquired by carrying out a login process, based on accumulated information produced by a computer of content distribution means such that user identification information of all users using said server and keywords of Web pages read by any of the users are associated with each other, based on the user identification information contained in the log data transmitted from said server, URLs contained in a category list, and information contained in the Web pages.
